(19) United States
(12) Patent Application Publication
(10) Pub. No.: US 2006/0209891 A1
(43) Pub. Date: Sep. 21, 2006

(54) Network QoS control system and method

(75) Inventors: Akiko Yamada, Kawasaki (JP); Hitoshi Yamada, Kawasaki (JP); Keiichi Nakatsugawa, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/205,866

(22) Filed: Aug. 17, 2005

(30) Foreign Application Priority Data
Mar. 18, 2005 (JP) 2005-080254

(51) Int. Cl. H04Q 7/24; H04Q 7/20; H04J 3/16

(52) U.S. Cl. 370/468; 370/338; 455/452.2

(57) ABSTRACT

When receiving a streaming service from a service provision server, a user terminal wants QoS assurance and issues a QoS request to a QoS control server together with a communicate request to a network. In this case, by including information about a plurality of access networks that the user terminal can access in a QoS request message, a QoS control server can optimally allocate resources in the current environment of the user terminal and assure. QoS. In this case, the format of this QoS request can accompany a communicate request from the user terminal or be independent of the communicate request.

### BACKGROUND OF THE INVENTION

1. Field of the Invention

The present invention relates to a network QoS control system for dynamically allocating a communication quality-assured route at end-to-end to a communication device having a plurality of communication interfaces and assuring quality of service (QoS).

2. Description of the Related Art

As a general network technology for realizing high-quality communication at end-to-end, there is a method for statically setting network equipment in such a way as to always assure some degree of communication quality on a contract base. However, if the respective providers of an access network and a core network are different or if layers for establishing a communication route are different, setting must be made independently for each network. Since this method secures resources if not necessary, this method lacks flexibility and secures resources wastefully.

There is also a method in which a communication device selects a route whose communication quality seems good by a means, such as a packet Internet groper (ping) or the like when starting communication. However, although communication quality is good at the beginning, there is no guaranty that communication quality is kept good until the end of communication.

Furthermore, if resources are reserved by resource reservation protocol (RSVP), a bandwidth is simply secured on a determined route and the situation of the entire network cannot be considered.

A packet network technology capable of conducting communication between terminal systems in a network composed of a plurality of terminal systems and switching equipment connected by a ring (see Patent reference 1) is also known.

As shown in FIG. 1, in Patent reference 1, if in a network system where a plurality of pieces of switching equipment S1-S6 are connected a ring, for example, a terminal M11 connected to switching equipment S1 communicates with a terminal M99 connected to switching equipment S5, there are two routes; one in which a packet reaches S5 from S1 via S3 and the other in which a packet directly reaches S5 from S1, and upon receipt of the packet addressed from M11 to M99, S1 determines which route is optimal by inquiring a network management station M10 of which route is optimal. However, in this optimal route selection method, the terminal M11 neither comprises a plurality of communication access means nor select a route reaching the partner terminal M99 determining which of the plurality of access networks should be used.

Furthermore, there is the prior application (see Patent reference 2) of this applicant enabling communication using an optimal route taking into consideration the respective states of a network and an application server.

As shown in FIG. 2, in Patent reference 2, if a client device 230 wants to receive content distribution, such as streaming or the like, from a content delivery network (CDN) system 140, a control device 240 collecting the additional information of distribution servers 1a-3a and network information selects an optimal distribution server and an optimal route.

However, in this optimal route selection method too, the client device 230 neither comprises a plurality of access means nor selects a route reaching the distribution servers 1a-3a, being its communication partners, taking into consideration which of the plurality of access networks should be used.

Patent reference 1: Japanese translation of PCT international patent application publication No. H09-508509

Patent reference 2: WO04/073269 (Japanese Patent Application No. 2004-568180)

### SUMMARY OF THE INVENTION

Neither of the above-described prior arts can determine which of a plurality of communication access means should be used to conduct quality-assured communication taking into consideration the entire network when a user has the plurality of communication access means. Furthermore, since it is not assumed that a communication device moves, resources cannot be smoothly allocated when the communication device moves.

As to a method in which communication devices that want to communicate negotiates about a protocol, a medium and a bandwidth, RFC2327 regulates a method using session description protocol (SDP) of session initiation protocol (SIP). Furthermore, although Multiparty Multi-media Session Control (MMUSIC)-Working Group (WG)(http://www.ietf.org/html.charters/mmusic-chart er.html) further discusses it, it does not include negotiation on charging. In this case, for example, if it is determined that only a requester is charged for QoS-assured communication or if a flat rate is adopted, there is no problem. However, if quality-assured communication is charged by a measured-rate system, it cannot be freely determined which bears quality-assured communication service charge, an originating side or a terminating side when starting communication, which is a problem.

It is an object of the present invention to provide a QoS control system for optimally allocating resources in an environment where a communication device is placed and assuring QoS and a control method of thereof.

In order to solves the above-described problem, if a terminal user has a plurality of communication access means, the user determines which of the communication access means is optimally suited to conduct quality-assured communication, taking into consideration the entire resources of a network and determines an optimal route.

According to the present invention, a probability that a terminal user can receive QoS assurance is improved, and also a network provider can increase service provision throughput.

### BRIEF DESCRIPTION OF THE DRAWINGS FIG. 1 shows the conventional network technology enabling communication between terminal systems in an optimal route.

FIG. 2 shows the prior invention of this applicant enabling communication in an optimal route taking into consideration the respective states of a network and an application server.

FIG. 3 shows the basic configuration of the network QoS control system in the first preferred embodiment of the present invention.

FIG. 4 shows the basic QoS control packet format.

FIG. 5 shows an example of the packet format of a QoS request message (reservation).

FIG. 6 shows an example of the packet format of a QoS request message (reservation response).

FIG. 7 shows the functional configuration of the QoS control server in the first preferred embodiment of the present invention.

FIG. 8 is the QoS setting sequence chart in a network of the first preferred embodiment of the present invention shown in FIG. 3.

FIG. 9 shows the QoS request packet format of the first preferred embodiment of the present invention.

FIG. 10 is the flowchart of the QoS control server shown in FIG. 7 performing session identification.

FIG. 11 is the flowchart of determining an optimal route in the QoS control server.

FIG.12 shows an example of the QoS response packet format in the first preferred embodiment of the present invention.

FIG. 13 shows an example of the session management table of the QoS control server in the first preferred embodiment of the present invention.

FIG. 14 shows the configuration of the communication device set forth in Japanese Patent Application No. 2004-050589.

FIG. 15 shows the basic configuration of the network QoS control system in the second preferred embodiment of the present invention.

FIG. 16 is the QoS setting sequence chart in a network of the second preferred embodiment of the present invention shown in FIG. 15.

FIG. 17 shows the QoS request packet format in the second preferred embodiment of the present invention.

FIG. 18 shows an example of the QoS response packet format in the second preferred embodiment of the present invention.

FIG. 19 shows the basic configuration of the network QoS control system in the third preferred embodiment of the present invention.

FIG. 20 is the QoS setting sequence chart in a network of the third preferred embodiment of the present invention shown in FIG. 19.

FIG. 21 shows the QoS request packet format of the third preferred embodiment of the present invention.

FIG. 22 shows the basic configuration of the network QoS control system in the fourth preferred embodiment of the present invention.

FIG. 23 is the QoS setting sequence chart in a network of the fourth preferred embodiment of the present invention shown in FIG. 22.

FIG. 24 shows an example of a message including QoS request contents in SIP invite request.

FIG. 25 shows the basic configuration of the network QoS control system in the fifth preferred embodiment of the present invention.

FIG. 26 is the QoS setting sequence chart in a network of the fifth preferred embodiment of the present invention shown in FIG. 25.

FIG. 27 shows the basic configuration of the network QoS control system in the sixth preferred embodiment of the present invention.

FIG. 28 shows the basic configuration of the network QoS control system in the seventh preferred embodiment of the present invention.

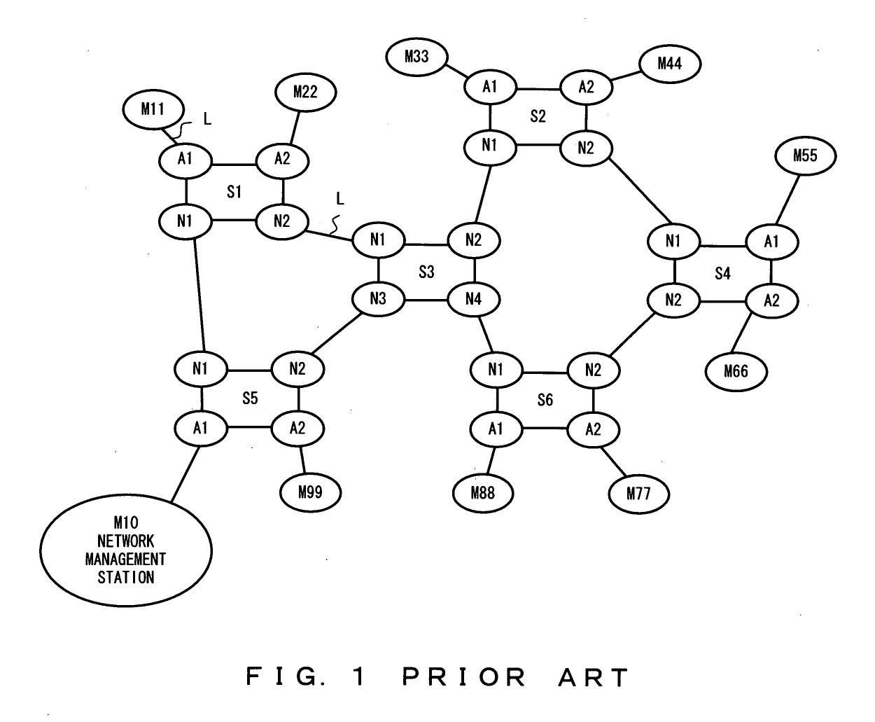

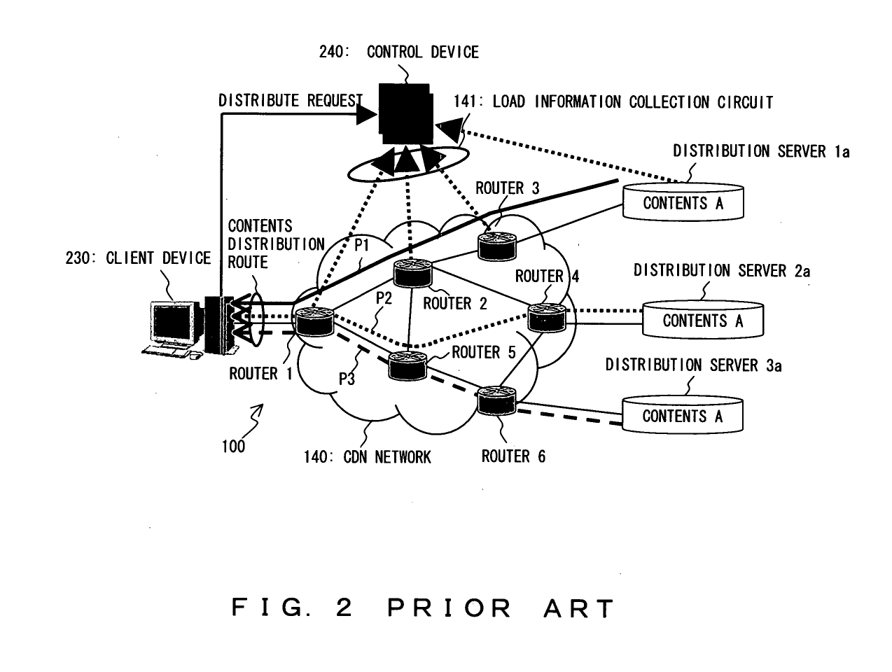

### DESCRIPTION OF THE PREFERRED EMBODIMENTS

The preferred embodiments of the present invention are described below with reference to the drawings.

[The First Preferred Embodiment]

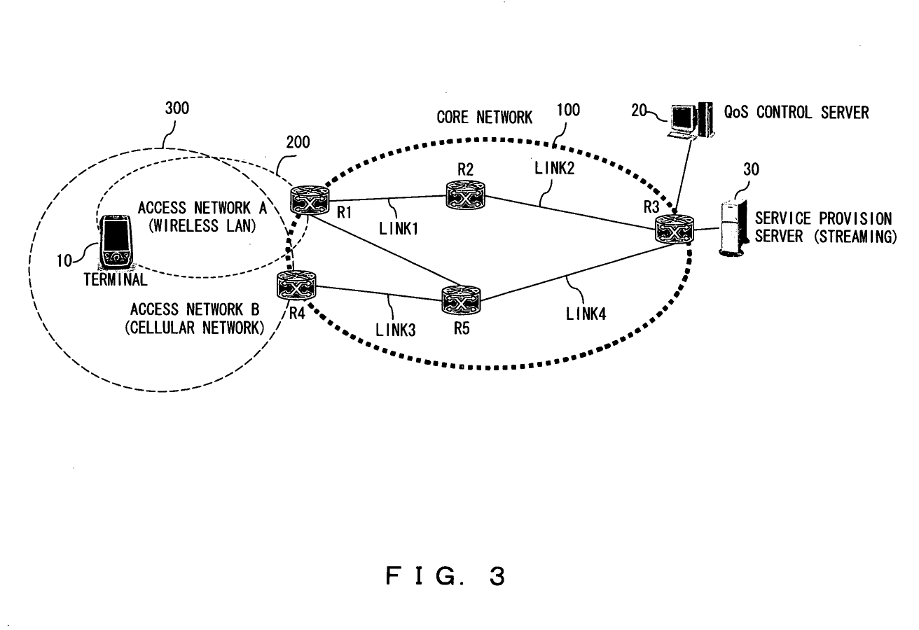

FIG. 3 shows the basic configuration of the network QoS control system in the first preferred embodiment of the present invention. In the first preferred embodiment shown in FIG. 3, as a network environment, a core network 100 is used, as an access means, a wireless LAN 200 and a cellular network 300 which are provided by an Internet service provider (ISP) are used, and as a communication device, a terminal 10 accessible to the cellular network 300 and wireless LAN 200. In the network configuration of the first preferred embodiment of the present invention shown in FIG. 3, the terminal (communication device) 10 issues a request packet which is currently accessible to the access network A (wireless LAN) 200 and access network B (cellular network) 300 and asks for QoS assurance when receiving a contents distribution service, such as streaming from a service provision server 30 or the like, from the access network A toward a QoS control server 20. The core network 100 comprises routers R1 through R5. As an example, router R1 is connected to R2 via a link 1 or is connected to R5 via a link 5, router R2 is connected to R3 via a link 2, router 4 is connected to R5 via a link 3, and router 5 is connected to R3 via a link 4. The router R1 functions as a default gateway and connects the access network A (wireless LAN) 200 and core network 100. The router 4 functions as a default gateway and connects the access network B (cellular network) 300 and the core network 100. Each of the QoS control server 20 and service provision server 30 for providing a streaming service is connected to the core network 100 via the router R3. The terminal 10 shown in FIG. 3 has an IP address (10.10.0.1) in the access network A 200, and the router R1 as its gateway has an IP address (10.10.0.253). The terminal 10 has an IP address (10.20.0.1) in the access network B 300, and the router R4 as its gateway has an IP address (10.20.0.253). Furthermore, it is assumed that the service provision server 30 has an IP address (10.30.0.1). Currently, it is assumed that the links 1 through 5 have a available bandwidth of 2 Mbps in the direction of router R2→R1, a available bandwidth of 10 Mbps in the direction of router R3→R2, a available bandwidth of 30 Mbps in the direction of router R5→R4, a available bandwidth of 50 Mbps in the direction of router R3→R5 and a available bandwidth of 4 Mbps in the direction of router R5→R1, respectively. Although the core network 100 shown in FIG. 3 comprises router R1 through R5 as routers, in an actual network, the number of routers is not limited to this.

In the network QoS control system shown in FIG. 3, if the communication device 10 currently wants Qos-assured communication, a QoS request packet is issued to the QoS control function in the network, that is, the QoS control server 20 via a communication access path of either the access network A (wireless LAN) 200 or access network B (cellular network) 300. The format of this QoS request can accompany the communication request or be independent. In this preferred embodiment, the description is made assuming that it is an independent request, the details of which are described later.

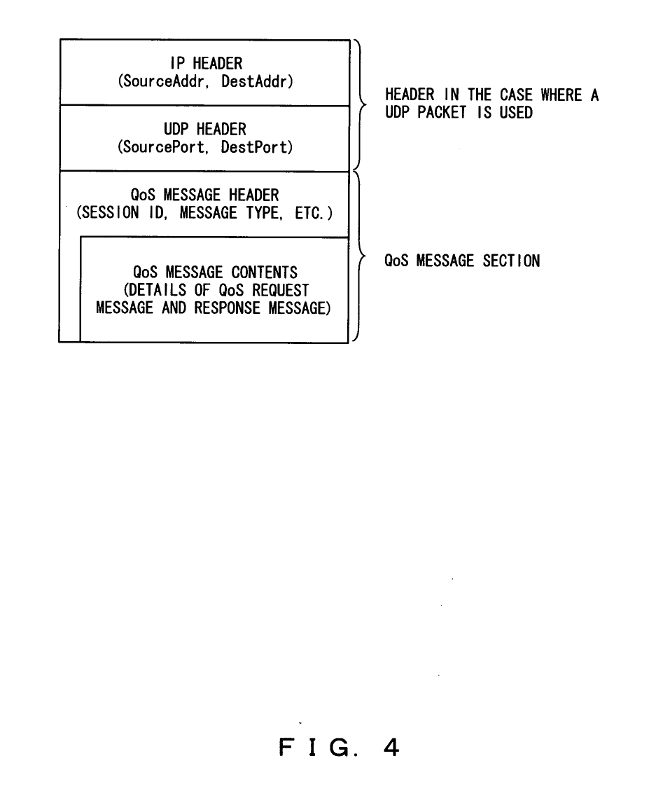

FIG. 4 shows the basic QoS control packet format. The QoS control packet shown in FIG. 4 comprises a header used when a user datagram protocol (UDP) is used and a QoS message section. In the case of an UDP packet, the header includes an IP header and an UDP header. The QoS message section includes a QoS request message and QoS message contents. The QoS message contents include the respective details of a QoS request message and a response message.

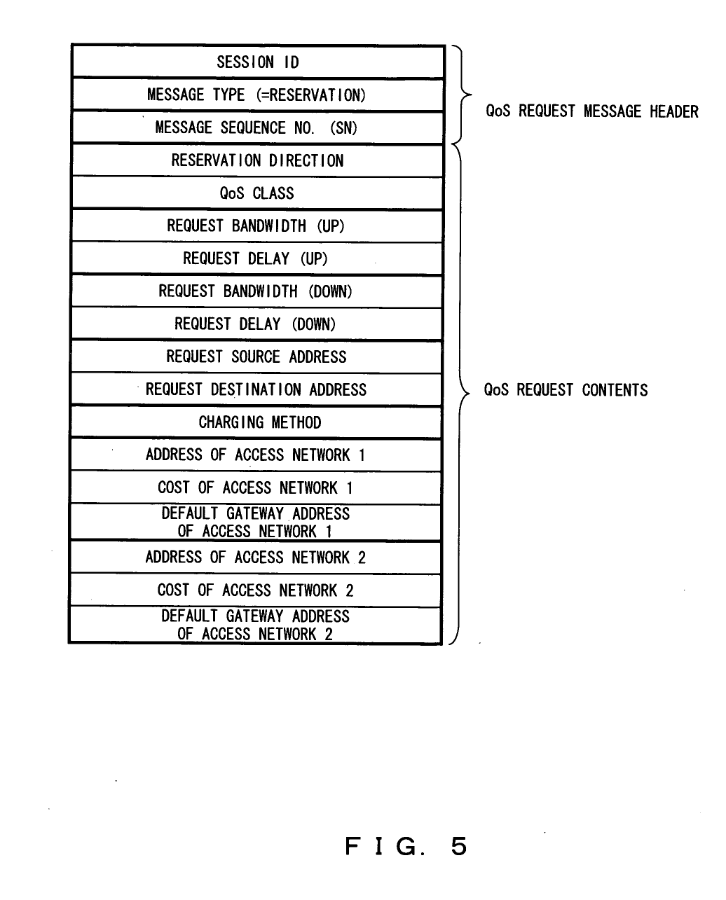

FIG. 5 shows an example of the packet format of the QoS request message in the QoS message section shown in FIG. 4. This packet format is an example of that of a reservation message. The reservation message shown in FIG. 5 comprises a QoS request message header and QoS request contents. The QoS request message header includes a session ID, a message type (=reservation) and a message sequence number (SN). The QoS request contents includes a reservation direction, a QoS class, a requested bandwidth and a request delay for each communication direction (up and down), a request source address, a request destination address, a charging system, an address in the first access network, the cost of the first access network, a default gateway address in the first access network, an address in the second access network, the cost of the second access network and a default gateway address in the second access network.

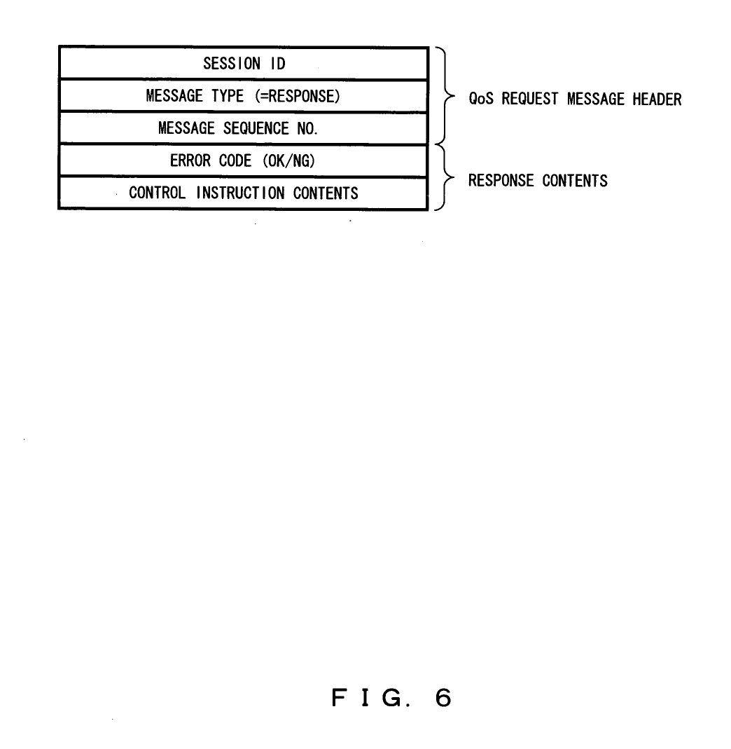

FIG. 6 shows an example of the packet format of the response message to the reservation message shown in FIG. 5. The response message shown in FIG. 6 comprises a QoS request message and response contents. The QoS request message header includes a session ID, a message type (=response) and a message sequence number (SN). The response contents include an error code (OK/NG) and control instruction contents.

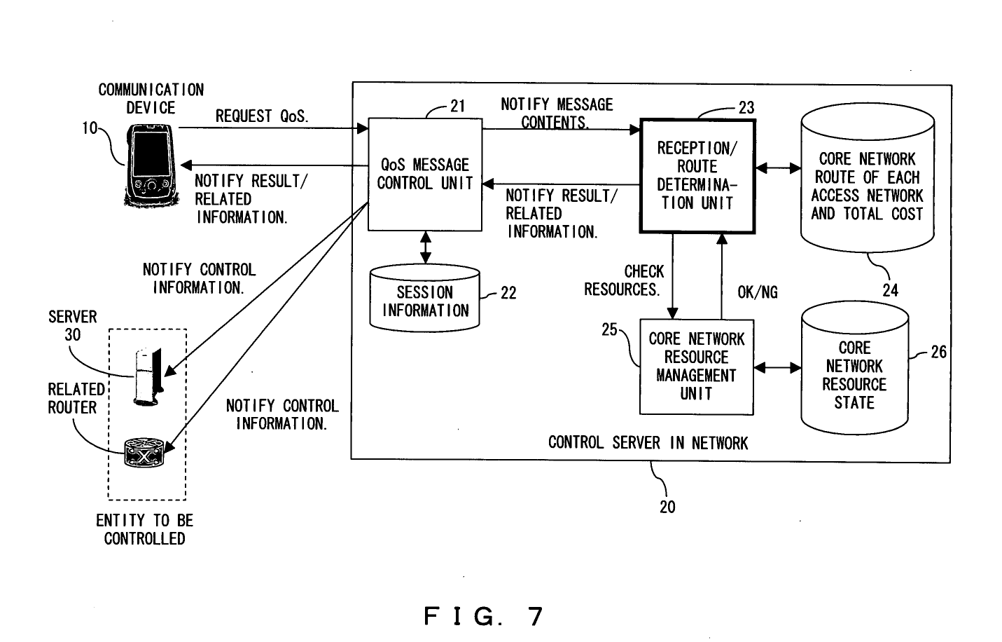

FIG. 7 shows the functional configuration of the QOS control server in the first preferred embodiment of the present invention, in which all functions centered on a QoS control server for performing the QoS control function of a network. As shown in FIG. 7, the QoS control server 20 comprises a QoS message control unit 21, a reception/route determination unit 23 and a core network resources management unit 25. The QoS message control unit 21 receives a QoS request message from the communication device (terminal) 10, and notifies the reception/route determination unit 23 of message contents while referring to session information stores in a session information storage unit 22. Then, the message control unit 21 receives a process result and related information based on this notification from the reception/route determination unit 23 or notifies the terminal 10 of the process result and related information of the QoS request message. The reception/route determination unit 23 refers to the core network route for each access network and total cost information stored in a core network route/total cost storage unit 24. The reception/route determination unit 23 also checks the resources of a core network resource management unit 25 and performs resource allocation and route determination. The core network resource management unit 25 refers to the resource state of a core network stored in a core network resource state storage unit 26, and notifies the reception/route determination unit 23 of an OK/NG result of resource allocation. Furthermore, the QoS message control unit 21 notifies an entity which must be controlled (the service provision server 30 and related router, such as router R3) of its control information.

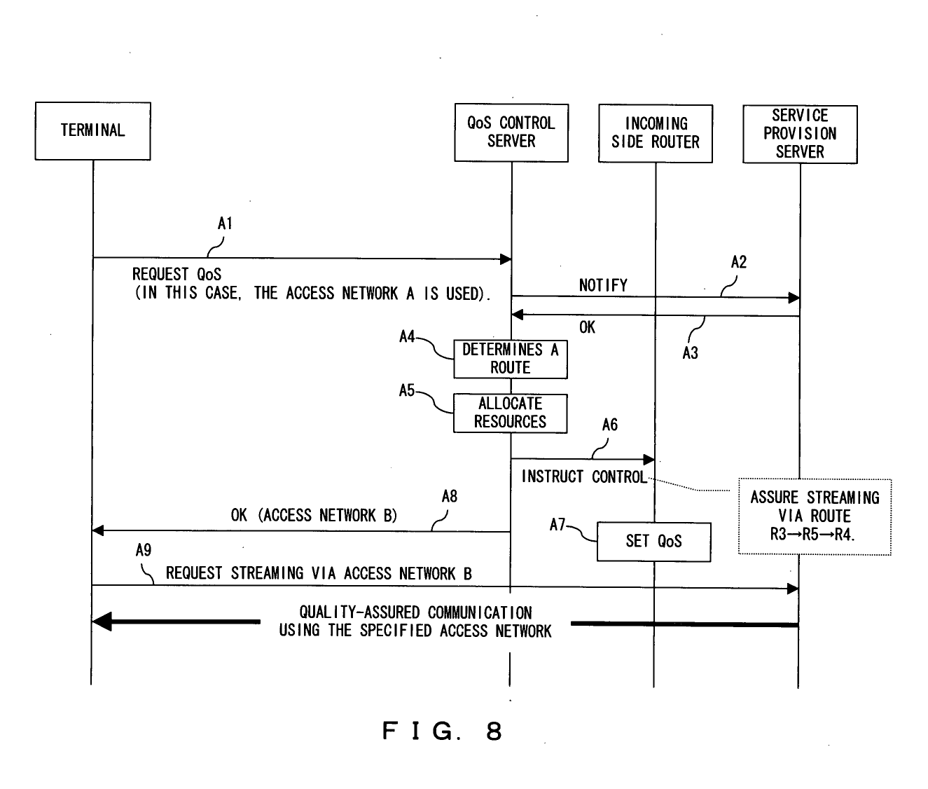

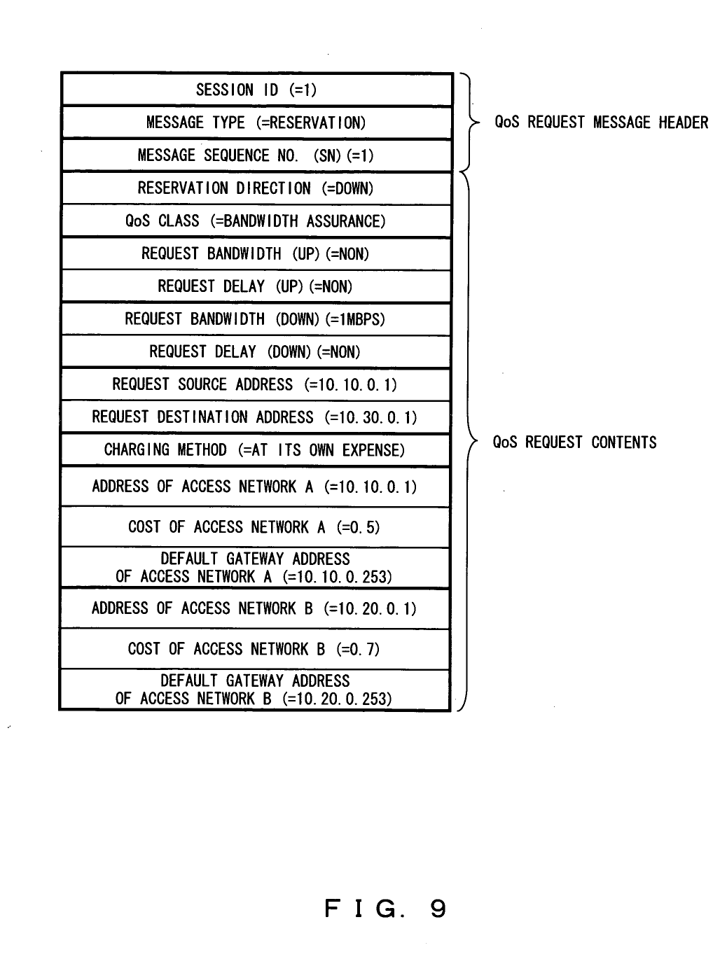

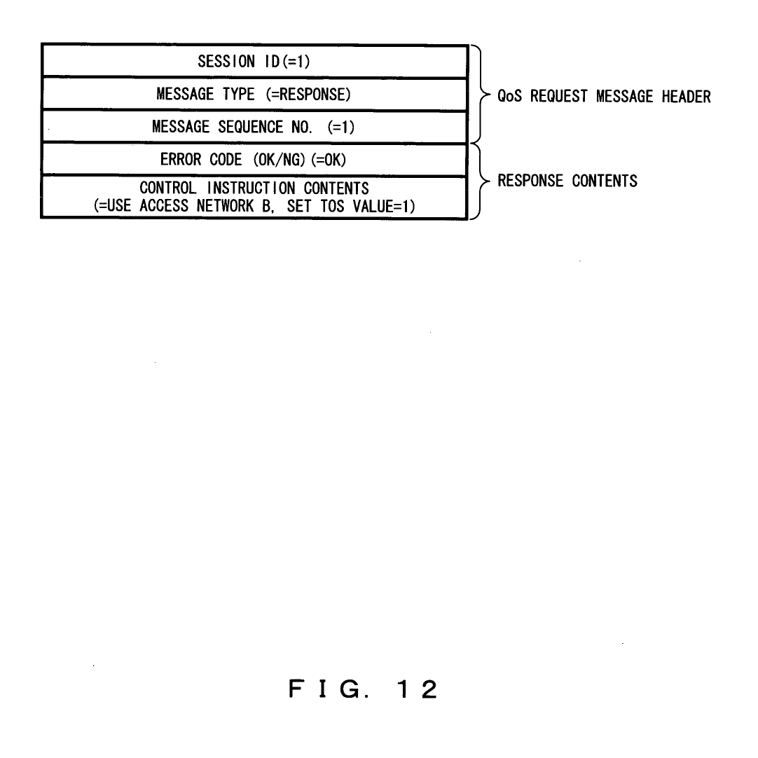

The operation of the network QoS control system in the first preferred embodiment of the present invention is described in detail below with reference to FIGS. 3, 7 through 14. FIG. 8 is the QoS setting sequence chart in a network of the first preferred embodiment of the present invention shown in FIG. 3. In FIG. 8, the terminal 10 issues a QoS request, using the QoS request packet shown in FIG. 9 via the access network A 200 (A1) . The QoS control server 20 notifies the service provision server 30 of the QoS request packet (A2). The service provision server 30 reads information in the QoS request packet (see FIG. 9) and knows that the terminal 10 wants 1 Mbps bandwidth assurance in the down direction at its own expense. Then, the service provision server 30 confirms that there is no problem in the service provision and returns OK to the QoS control server 20 (A3). If the service provision server 30 wants to refuse to provide QoS assurance, it returns a response packet described to be NG. Then, the QoS control server 20 determines an optimal route (A4). Then, the QoS control server 20 allocates resources (A5) . Then, the QoS control server 20 gives a control instruction to an incoming side router R3 (A6) . In this case, the control instruction to the incoming side router R3 is to assure streaming in a route of R3→R5→R4. As a technology for transferring a packet with a clearly specified route, for example, there is a method using a multi-protocol label switching (MPLS) technology currently used in a core network generally. The incoming side router R3 that wants a control instruction sets QoS (A7) . The QoS control server 20 notifies the terminal 10 that OK is issued for QoS-assured communication via the access network B 300, using a response packet described so (see FIG. 12) (A8). The control instruction contents of a response packet can include not only an access network but also the contents on QoS setting, such as a TOS value (the value of the type-of-service field of an IP header) indicating a QOS assurance class. Upon receipt of the notice of QoS assurance, the terminal 10 issues a streaming service request to the service provision server 30 via the access network B 300 (A9). If the notice includes a specified TOS value, the terminal 10 notifies the service provision server 30 of this. Upon receipt of this request, the service provision server 30 performs streaming for the request source of the streaming with the specified TOS value. This flow is accommodated into a path specified by the incoming side router R3, and QoS is assured. As the specification method of the TOS value, a method of notifying the service provision server 30 by the QoS control server 20 can also be considered besides the above described.

The QoS request contents in the QoS request packet format shown in FIG. 9 describes that its message type is reservation, a 1 Mbps down bandwidth is assured and it is charged at its own expense, and streaming is performed with a 1 Mbps down bandwidth assurance. If the access networks A and B are used as a plurality of available access network candidates, their addresses of the terminal (network A address=10.10.0.1 and network B address=10.20.0.1), default gateway addresses (network A address=10.10.0.253 and network B address=10.20.0.253) are also described. Furthermore, their cost values calculated based on an access network state in the environment of the terminal 10 (network A cost=0.5 and network B cost=0.7) are described. In this case, the down direction means the direction of information viewed from the core network side.

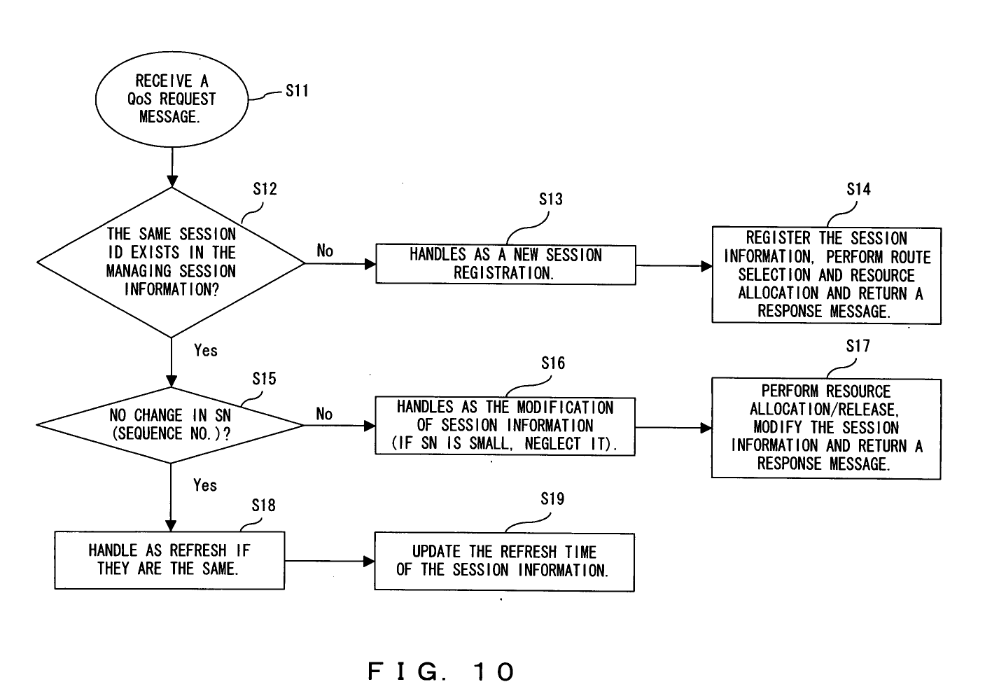

FIG. 10 is the flowchart of the QoS control server shown in FIG. 7 performing session identification. When receiving a QoS request message from the terminal 10 in FIG. 3 or 10 (S11), the QoS control server 20 determines whether the same ID exists in managing session information (S12). If no same session ID exists, it is handled as a new session registration (S13). Then, the QoS control server 20 registers the session information, performs route selection and resource allocation, and returns a response message (S14), which is described later. If the same session exists, the QoS control server 20 determines whether to modify SN (sequence number) (S15). If the SN is modified, it is handled as the modification of session information (however, if the SN is small, it is neglected)(S16). Then, resources are secured, released, the session information is modified, and a response message is returned (S17). If it is not modified, it is handled as refresh if the SN is the same (S18). Then, the QoS control server 20 modifies the refresh time of the session information in order to maintain the connection (S19).

As described above, upon receipt of a new QoS request message from the terminal 10, the QoS control server 20 registers this request message as a new session (S11-13). Then, the QoS control server 20 determines the route of the new session and secures its resources (S14). Then, the QoS control server 20 allocates the resources, that is, updates the available bandwidth information of a link constituting the determined route.

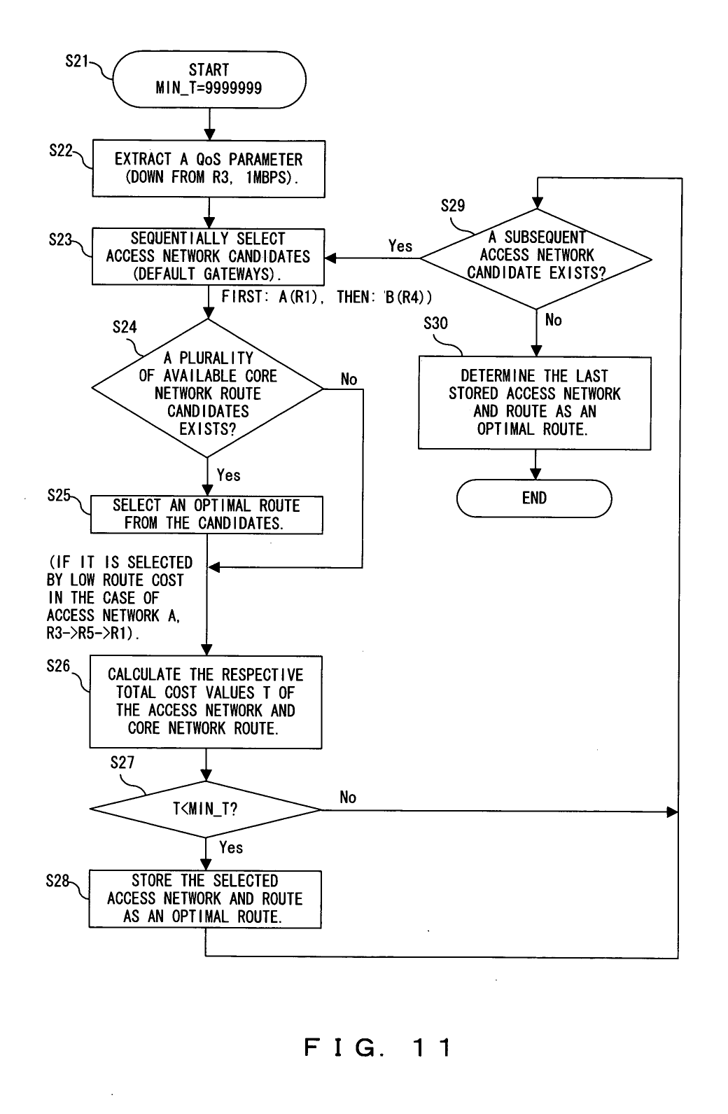

FIG. 11 is the flowchart of determining an optimal route in the QoS control server shown in FIG. 7. Upon receipt of the QoS request message in FIG. 11, the QoS control server 20 firstly initiates MIN₁₃T (set it to a maximum value, for example, 9999999) when starting an optimal route determination process (S21). Then, the QoS control server 20 checks the QoS request contents in the QoS request packet and extracts a QoS parameter (S22). Specifically, the parameter includes a request destination address 10.30.0.1 (gateway is R3), the down direction, 1Mbps bandwidth assurance, and access network A [address 10.10.0.1 (gateway is R1)] and access network B [address 10.20.0.1 (gateway is R4)] as access network candidates. Then, the QoS control server 20 sequentially selects the access network candidates (default gateways) (firstly the router R1 of the access network A and then the router R4 of the access network B (S23). Then, the QoS control server 20 checks whether there is an available core network route between the gateway of the selected access network and the gateway of the request destination address (S24) . If there is a plurality of routes, the QoS control server 20 selects one of the routes (S25). In the case of the network shown in FIG. 3, if it is selected by small route cost when it is a core network route candidate from the access network A 200, a route, router R3→R5→R1 is selected (S25). Then, the sum T of the cost of the selected core network and the cost of the access network (cost described in QoS request) is calculated (S26).

Although the calculation method of a core network cost can be variably defined, it becomes as follows if an algorithm is used such that a minimum available bandwidth becomes a maximum.

Core network cost value=Σ(1/available bandwidth of link constituting route) (expression 1) Then, total cost value T=access network cost value +ε* cost value of core network route connected to access network (expression 2)

(ε: coefficient for adjusting the respective weights of access network and core network)

Then, the QoS control server 20 determines whether the total cost value T is smaller than the maximum total cost value (MIN₁₃)(S27). If it is smaller than the maximum total cost value (MIN₁₃), the QoS control server 20 stores the selected access network and core network route as an optimal route (S28). Then, the QoS control server 20 checks whether there is a subsequent access network candidate (S29). If there is a subsequent access network, the process returns to step S23, and steps S23 and after are repeated. In the case of the network shown in FIG. 3, since there is the access network B, the process returns to step S23. If in step S27, it is not smaller than the maximum total cost value (MIN₁₃), the process proceeds to step S29 without storing the selected access network and core network route as an optimal route, and in step S29, the QoS control server 20 checks whether there is a subsequent access network. If there is no subsequent access network, the process proceeds to step S30, and the finally stored access network and core network route are determined as an optimal route. Then the process terminates. In other words, in the case of the network shown in FIG. 3, it is checked whether the total cost value T calculated using the access network B is smaller than MIN₁₃T. If it is smaller, it can be determined that the route calculated using the access network B is more optimal than the route calculated using the access network A. In this case, the QoS control server 20 stores the selected access network B as an optimal route and also updates MIN₁₃T. Since there is no subsequent candidate, the finally stored optimal access network and route is determined to be a final optimal route. Specifically, the route calculated using the access network B is determined to be a final optimal route.

As shown in FIG. 9, the cost values of the access networks A 200 and B 300 are described to be 0.5 and 0.7, respectively. The access network candidates for calculating an optimal route becomes a route via links 1 and 2 (hereinafter called “(A-1)”) or a route via links 4 and 5 (hereinafter called “(A-2)”) in the case of the access network A 200, and becomes a route via links 3 and 4 (hereinafter called “(B)”) in the case of the access network B 300. Available bandwidths allocated for QoS class bandwidth assurance are as follows.
Link 1: 2 Mbps
Link 2: 10 Mbps
Link 3: 30 Mbps
Link 4: 50 Mbps
Link 5: 4 Mbps
   In this case, if coefficient ε=1,the total cost values T of the above-described three routes are as follows.
   Total cost value (A-1)=0.5+½+ 1/10=1.1 (expression 3)
   Total cost value (A-2) 0.5 +¼+ 1/50=0.77 (expression 4)
   Total cost value (B) =0.7 + 1/30+ 1/50=0.753 (expression 5)

Therefore, the QoS control server 20 determines to assure with a route (route via links 3 and 4) using the access network B 300 shown in expression 5 with the smallest total cost value T, for this QoS request. The QoS control server 20 receives the OK of the service provision server 30 and determines a route as described above. Simultaneously, the QoS control server 20 actually allocates a bandwidth and instructs to set QoS assurance in a router. Simultaneously, the QoS control server 20 notifies the terminal 10 that QoS assurance using the access network B 300 is OK (see the response packet shown in FIG. 12). The control instruction contents of the response packet can include not only the instruction on an access network but also contents on QoS setting, such as the setting of a TOS value and the like.

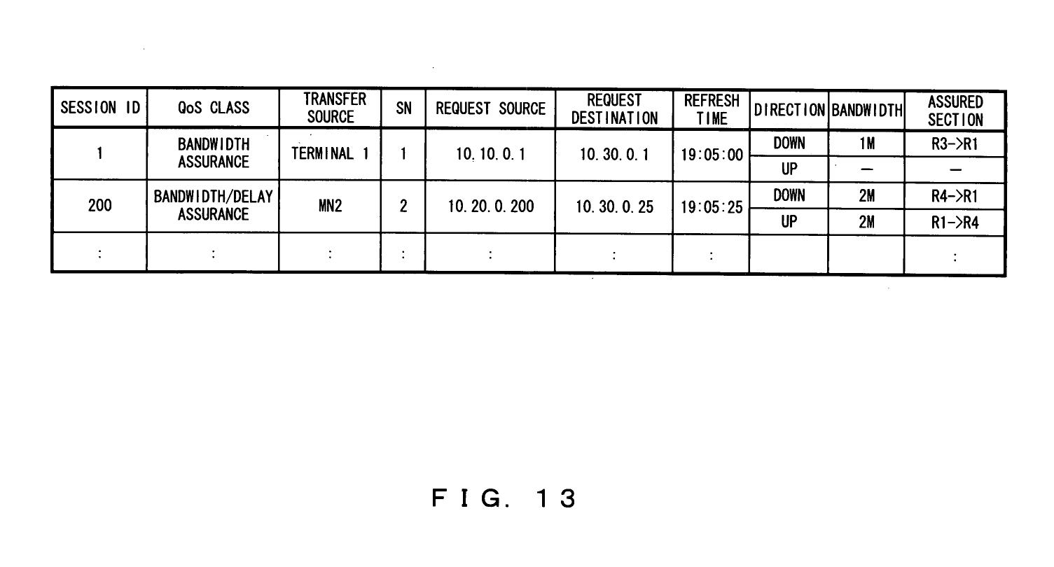

FIG. 13 shows an example of the session management table of the QoS control server in the first preferred embodiment of the present invention. The QoS control server 20 shown in FIGS. 3 or 7 manages the conducted state of quality-assured communication as session information using the management table shown in FIG. 13. The session information describes necessary information about each of a QoS class indicating assurance contents, such as bandwidth assurance or the like, a transfer source, a sequence number (SN), a request source address, a request destination address, a refresh time, direction, a bandwidth and a assured section, for each session ID.

Although in the above description, the cost value of each of the access networks A and B of the terminal 10 is known beforehand, sometimes a request message includes a delay value, wave intensity, an available bandwidth and the number of connected users, as information indicating the state of an access network, such as parameters indicating the state of each access network. Therefore, the cost value of an access network can also be calculated according to an expression and be used. In other words, a cost value obtained by comprehensively determining parameters indicating the state of an access network can also be used.

A cost value including a delay value, wave intensity, an available bandwidth and the number of connected users can be calculated as follows.
Access network cost value =M*[{α*number of connected users}+{β*measured delay value}+{γ/available bandwidth}+{ξ/wave intensity}] (expression 6)

In the above expression, α, β, γ and ξ are coefficients for standardizing each parameter or adjusting the weight of each parameter. M is a coefficient which the network manager empirically gives taking into consideration an application characteristic and an access network characteristic. For example, if streaming is applied, it can be considered that a wireless LAN is more inexpensive and preferable than a 3 G cellular network as an access network. Therefore, if it is defined beforehand as follows, a wireless LAN can be selected with priority.
M(streaming, 3G)>M(streaming, wireless LAN) (expression 7)

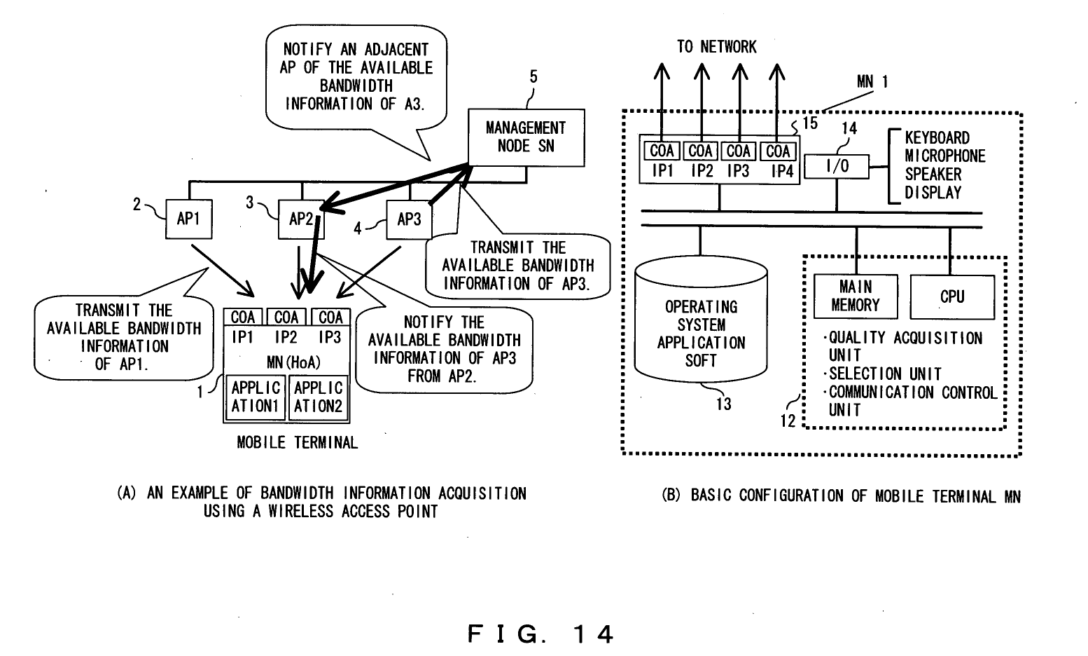

FIG. 14 shows the configuration of the communication device set forth in this applicant's Japanese Patent Application No. 2004-050589 so that a terminal can obtain the communication quality information of an access network. In FIG. 14A, wireless LAN access points (AP) 2-4 can measure how many mobile terminals MN belong to it or how much its traffic is. Therefore, by calculating an available bandwidth and broadcasting it from the wireless LAN access points (AP 1-3) 2-4 to a mobile terminal MN1, for example, as available bandwidth information, the mobile terminal MN1 can catch the available bandwidth information of the access network (wireless LAN) . If a management node SN5 is provided, each of wireless LAN access points (AP) 2-4 notifies the management node 5 of its own available bandwidth and one of the wireless LAN access points (AP) 2-4 distributes necessary information to another of the wireless access points (AP) 2-4, not only its own information but also information obtained from the management node SN5 can be notified to the mobile terminal MN1. Then, as shown in FIG. 14B, the mobile terminal (MN) 1 can bring quality information obtained the access points (AP) 2-4 in the quality acquisition unit in the control device and use it.

As described above, if a communication device (terminal) wants QoS-assured communication, in the network QoS control system in the first preferred embodiment of the present invention, the QoS control function of the network can determine which access network be used in order to efficiently transfer data by transmitting a QoS request message packet (see FIGS. 5 and 9) to the QoS control function of a network using an arbitrary communication access path, and including information (address, cost, default gateway address and the like) about an access network that can be accesses while taking into consideration a plurality of route candidates by the communication device (terminal) in the current environment of the communication device (terminal) in the QoS request message packet.

According to the first preferred embodiment of the present invention, if a plurality of access networks are available in the current environment of the communication device, the number of route candidates increases by the so many number of the access networks. Therefore, even if an arbitrary place of an access network or core network is congested and QoS-assured communication is unavailable when using a specific access network, QoS-assured communication can be provided using another access network. In other words, the probability that a terminal user can enjoy QoS assurance can be improved, and a network provider can increase its service provision throughput. Furthermore, if a terminal user wants a specific access network and there are a plurality of core network routes are available, the resources of the core network can be efficiently allocated and a route can be selected by setting a cost value in such a way as to increase the cost value of a route with a few available bandwidth and selecting a core network route.

[The Second Preferred Embodiment]

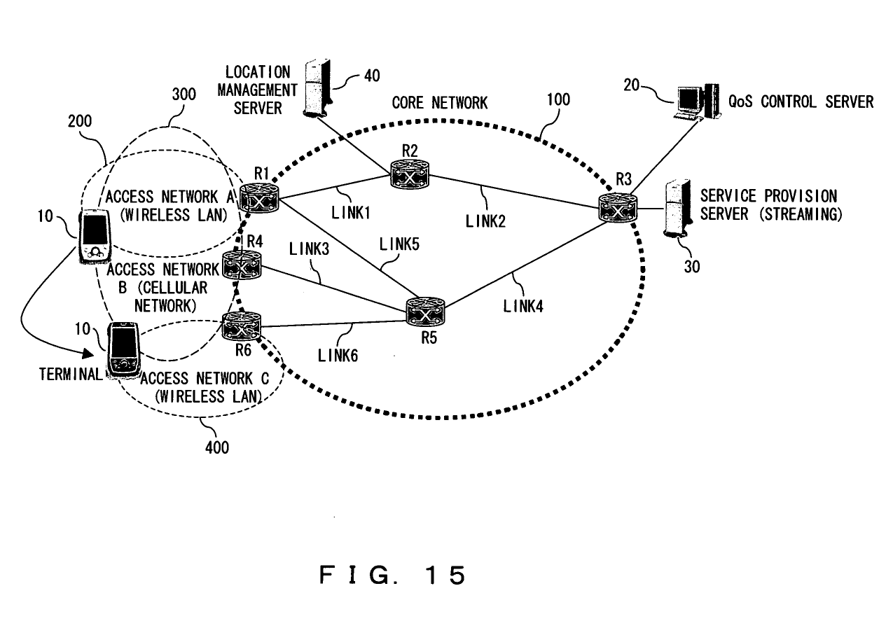

In the network QoS control system in the second preferred embodiment of the present invention, the QoS resource reservation can be dynamically modified at end-to-end when a communication device (terminal) moves in the QoS control system of the first preferred embodiment and uses another access network. The configuration and operation of the network QoS control system in the second preferred embodiment of the present invention are described in detail with reference to FIGS. 7, 10, 15 through 18. FIG. 15 shows the basic configuration of the network QoS control system in the second preferred embodiment of the present invention. In FIG. 15, it is assumed that the terminal 10 has an IP address (10.20.0.1) in the access network B 300 and the router R4 as its gateway has an IP address (10.20.0.253). The terminal 10 has also an IP address (10.40.0.1) in an access network C 400 and the router R6 as its gateway has an IP address (10.40.0.253). Furthermore, the service provision server 30 has an IP address (10.30.0.1). It is also assumed that currently the links 1 through 6 have a available bandwidth of 2 Mbps in the direction of router R2→R1, a available bandwidth of 10 Mbps in the direction of R3→R2, a available bandwidth of 10 Mbps in the direction of R5→R4, a available bandwidth of 40 Mbps in the direction of R3→R5, a available bandwidth of 4 Mbps in the direction of R5→R1 and a available bandwidth of 10 Mbps in the direction of R5→R6, respectively. Although in the core network shown in FIG. 15, routers R1 through R6 are provided, the number of routers in an actual network configuration is not limited to this.

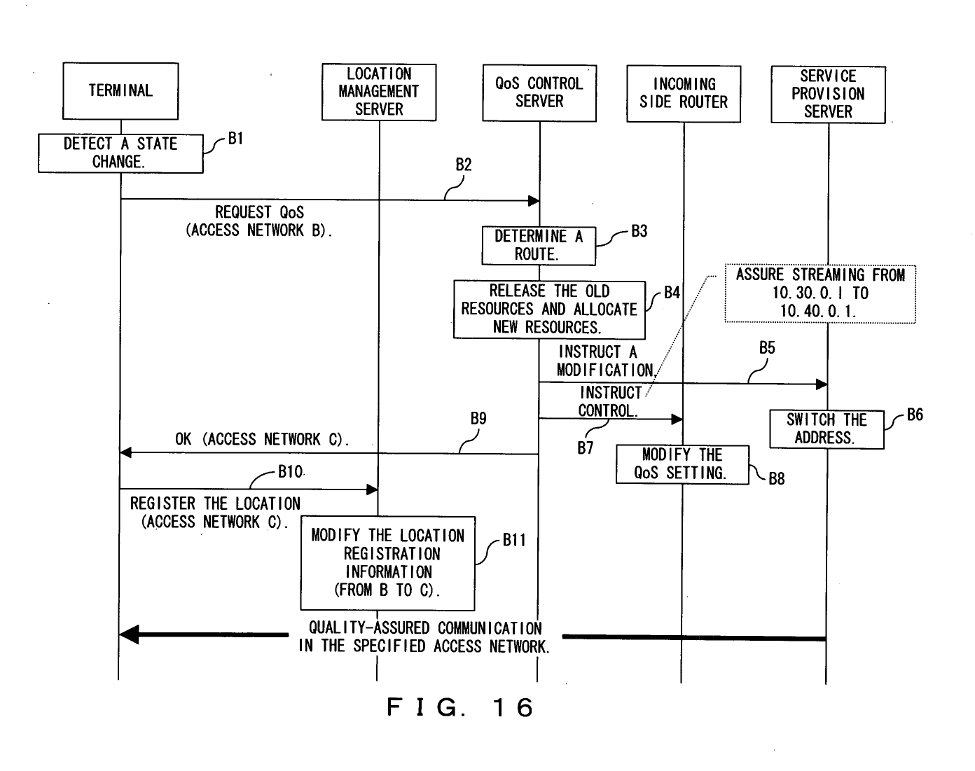

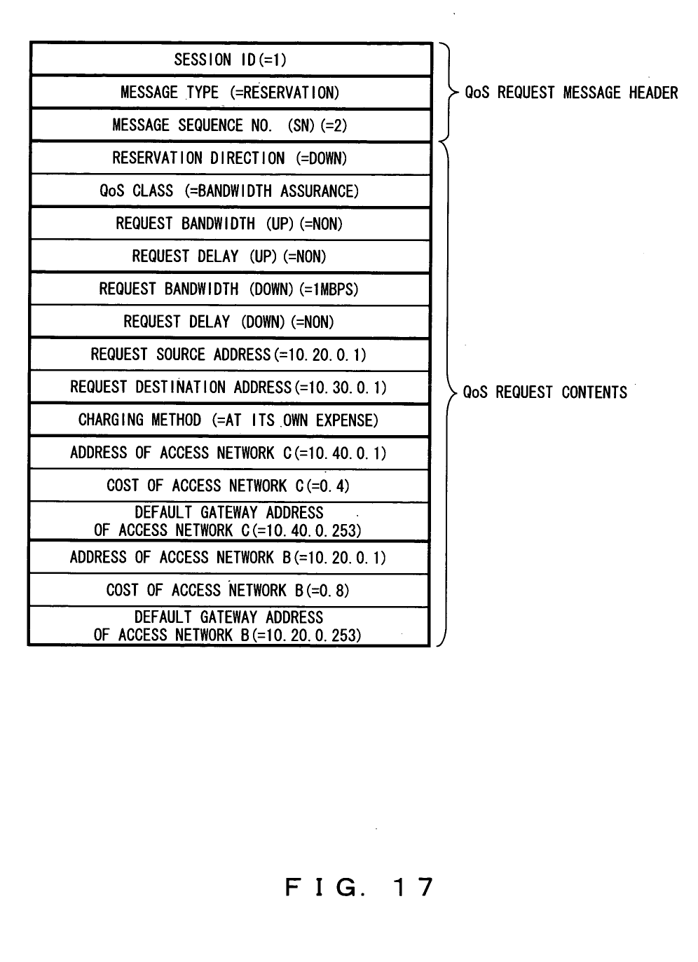

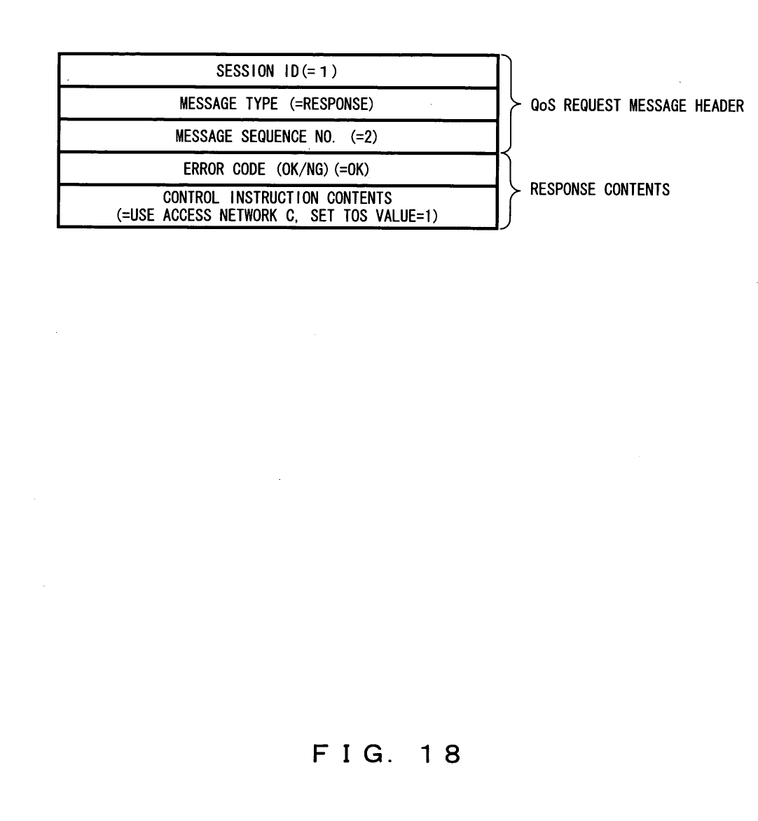

FIG. 16 is the QoS setting sequence chart in a network of the second preferred embodiment of the present invention shown in FIG. 15. In FIG. 16, the terminal 10 collects information about a network environment accompanying its movement, that is, available access points of a wireless LAN, the base station of a cellular network, each wave intensity, delay and the like beforehand and detects the state change of an access network (B1) . Then, the terminal 10 issues a new QoS request message in the format shown in FIG. 17 from the access network B (cellular network) 300 to the QoS control server 20 (B2) . The Qos control server 20 calculates a total cost value T according to the expression described on the first preferred embodiment of the present invention and determines an optimal route (B3). Then, as the terminal 10 moves from the access network B to C, the QoS control server 20 releases the old resources and allocates new resources (B4). Then, the QoS control server 20 instructs the service provision server 30 to modify the route and resources (B5) . The service provision server 30 switches the destination, based on this instruction (B6) The QoS control server 20 also instructs the incoming side router R3 to control (B7) to modify the QoS setting (B8). Then, the QoS control server 20 notifies the terminal 10 that QoS assurance via the access network C 400 is OK using a response packet (see FIG. 18) (B9) The terminal 10 registers its location in a location management server 40 (B10). The location management server 40 modifies location registration information (modifies the terminal location from the access network B to C)(B11).

FIG. 17 shows the QoS request packet format in the second preferred embodiment of the present invention. The QoS request packet format in the second preferred embodiment differs from the QoS request packet format in the first preferred embodiment in that the sequence number SN of the QoS request packet becomes 2 (SN=2) due to the modification of QoS resource reservation, the request source address changes from the IP address (10.10.0.1) to (10.20.0.1), and the access network A address, the cost of the access network A and the default gateway address of the access network A change to the access network C address, the cost of the access network C and the default gateway address of the access network C, respectively. The QoS control server 20 identifies a session according to the flowchart shown in FIG. 10 as in the first preferred embodiment and determines that this message is the update (modification) of the QoS assure request of the already received session ID=1 (S16), based on the fact that the sequence number changes to 2 (S15) after determining that the session ID is the same as before movement (S12). From the access network information included in this QoS request message, it is known that a new access network C 400 is attempted to use, further that the cost value of the access network B 300 increases (0.7→0.8) due to the increase of the number of connected users, the decrease of wave intensity and the like and that the available bandwidth of each of the links 3 and 4 decreases by 10 Mbps due to the update of the network resources. In this situation, the total costs of the access networks B 300 and C 400 are calculated as follows, as in the first preferred embodiment.
Total cost via access network C =0.4 + 1/10+ 1/40=0.525 (expression 8)
Total cost via access network B =0.8 + 1/10+ 1/40=0.925 (expression 9)

Therefore, the QoS control server 20 determines that the route via the access network C 400 is more appropriate since the total cost value calculated by expression 8 is smaller. Then, the QoS control server 20 determines the route via the access network C 400 as a final route, and releases the old resources and allocates new resources. In other words, the QoS control server 20 allocates a bandwidth. Specifically, the QoS control server 20 updates the available bandwidth information of the links constituting the determined route, and further releases the resources on the route before the modification by updating the available bandwidth information. Then, the QoS control server 20 instructs the streaming provision server 30 to switch the route. The streaming provision server 30 switches the destination (terminal address) and distributes contents, such as streaming or the like, to the new address. The contents of the control instruction from the QoS control server 20 to the incoming side router R3 is to assure the quality of streaming from the IP address (10.30.0.1) of the service provision server 30 to the IP address (10.40.0.1) in the access network C 400 of the terminal 10. In other words, it is instructed so that streaming data from the service provision server 30 to the terminal (access network C) 10 can be assured on a route R3→R5→R6.

FIG. 18 shows an example of the QoS response packet format in the second preferred embodiment of the present invention. The QoS response packet format in the second preferred embodiment differs from the QoS response packet format in the first preferred embodiment shown in FIG. 12 in that the message sequence number SN becomes 2 (SN=2) since it is the QoS response packet accompanying the movement of the terminal 10 and that the use of the access network C is described in the control instruction contents. Although the TOS value is maintained in this example, sometimes it is modified to one for QoS assurance on a new route.

As described above, according to the second preferred embodiment of the present invention, even if an ambient access network environment dynamically changes when a terminal moves, QoS-assured communication can be always conducted (continued) on an optimal route.

[The Third Preferred Embodiment]

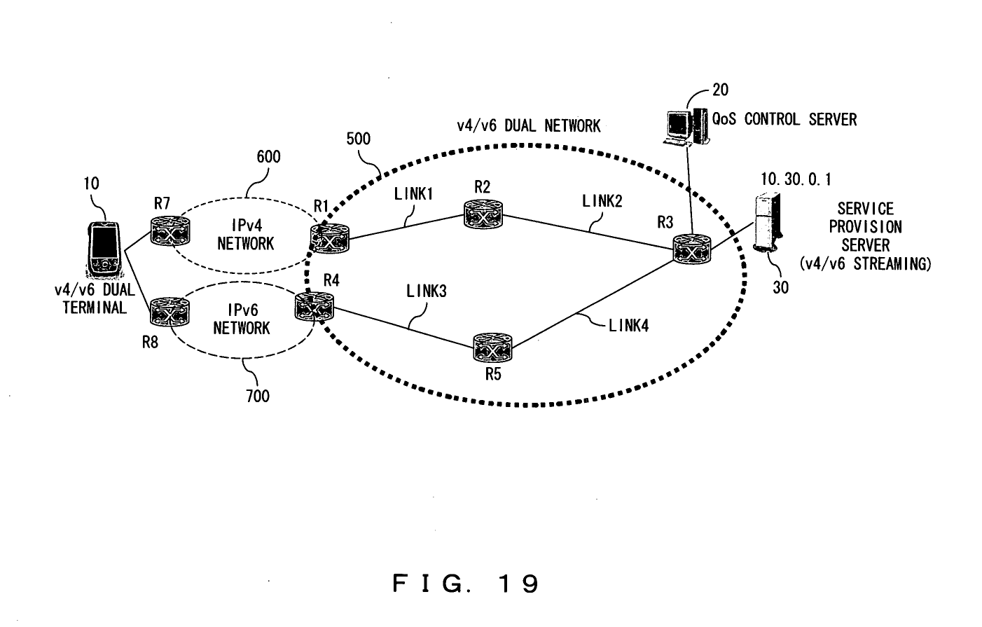

The configuration and operation of the network QoS control system in the third preferred embodiment of the present invention are described in detail with reference to FIGS. 7, 19 through 21. FIG. 19 shows the basic configuration of the network QoS control system in the third preferred embodiment of the present invention. In the third preferred embodiment shown in FIG. 19, as a network environment, a dual network 500 composed of networks to which Ipv4/Ipv6 conversion can be applied is used, as an access means, an ISP (Internet service provider) providing an Ipv4 network 600 and Ipv6 network 700 and as a communication device a terminal 10 accessible to the Ipv4 and Ipv6 networks. The network shown in FIG. 19 comprises the Ipv4 and Ipv6 networks, in which the terminal 10 can communicate via either of the Ipv4 and Ipv6 since it is a dual terminal. The service provision server 30 can also provide a service (streaming) via the network to which Ipv4/Ipv6 conversion can be applied. Even in such a network, the network QoS control system in the third preferred embodiment of the present invention can selects an optimal route and realize quality-assured communication. In FIG. 19, it is assumed that the terminal 10 has an IP address (10.10.0.1) in the access Ipv4 network 600, and the router R7 as its gateway has an IP address (10.20.0.253). The terminal 10 also has an IP address (FE80::100) in the access Ipv6 network, and the router R8 as its gateway has an IP address (FE80::253). Furthermore, the service provision server 30 has an IP address (10.30.0.1). It is also assumed that currently the links 1 through 4 have a available bandwidth of 2 Mbps in the direction of router R2→R1, a available bandwidth of 10 Mbps in the direction of R3→R2, a available bandwidth of 10 Mbps in the direction of R5→R4 and a available bandwidth of 40 Mbps in the direction of R3→R5, respectively.

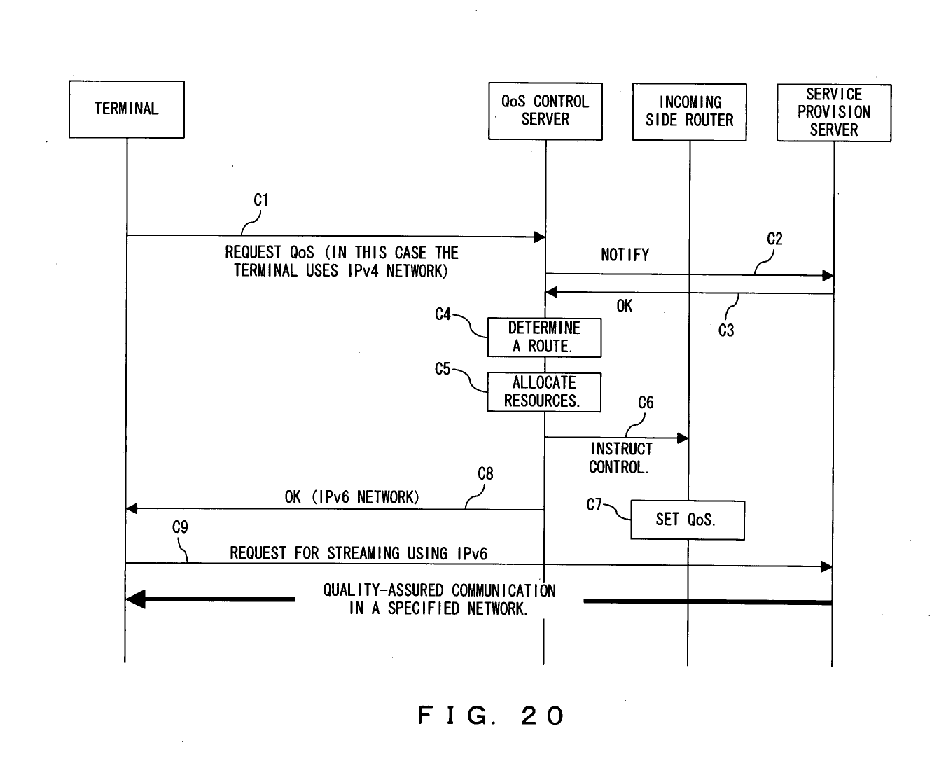

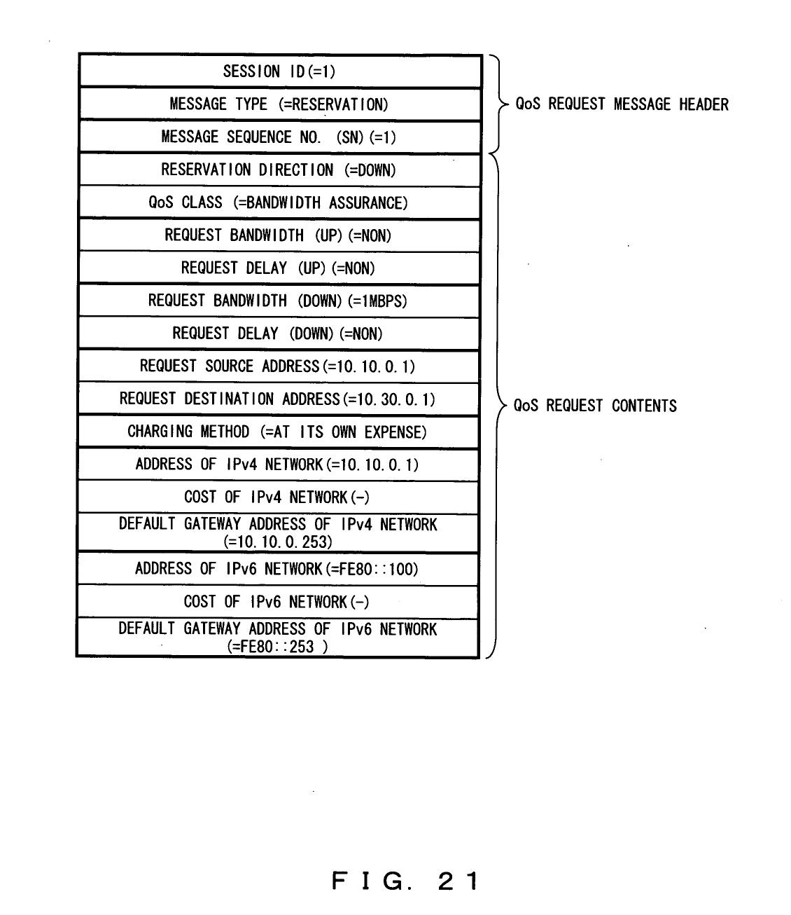

FIG. 20 is the QoS setting sequence chart in a network of the third preferred embodiment of the present invention shown in FIG. 19. In FIG. 20, the terminal 10 issues a QoS request from the Ipv4 network 600 (Cl). The QoS control server 20 receives the QoS request and when receiving the new session ID of a message, it registers this message as a new session. Furthermore, the QoS control server 20 notifies the service provision server 30, being its request destination, of the receipt of the QoS request (C2) . The service provision server 30 reads information (see FIG. 21) in the QoS request packet and knows that the terminal 10 wants 1 Mbps bandwidth-assured communication at its own expense. Then, the service provision server 30 confirms that there is no problem in the service provision and returns OK (C3). The QoS control server 20 determines the route of the new session and secures resources for the route. In other words, as in described above, the QoS control server 20 calculates a total cost value and determines an optimal route (C4). In this cost value calculation, the QoS control server 20 determines assurance on a route via the Ipv6 network. Then, the QoS control server 20 allocates resources (C5). The QoS control server 20 allocates a bandwidth, specifically, it updates the available bandwidth information of links constituting the determined route. Then, the QoS control server 20 gives a control instruction to the incoming side router R3 (C6). Its contents are that streaming data from the service provision server 30 to the terminal (Ipv6 address) 10 is assured on a route R3→R5→R4. Upon receipt of the control instruction, the incoming side router R3 sets QoS (C7). The QoS control server 20 notifies the terminal 10 that QoS-assured communication via the Ipv6 network 700 is OKed using a response packet (C8) . The terminal 10 issues a streaming request to the service provision server 30 from the Ipv6 network 700 (C9) . If a TOS value is specified at this moment, the terminal 10 notifies the service provision server 30 of the value. The service provision server 30 performs streaming for the streaming request source address using the specified TOS value. This flow is accommodated into a path specified by the incoming side router R3 and QoS is assured.

FIG. 21 shows the QoS request packet format of the third preferred embodiment of the present invention. This is basically the same as that of the QoS request message packet format of the first preferred embodiment shown in FIG. 9.

As described above, according to the third preferred embodiment of the present invention, the same effect of the first preferred embodiment of the present invention can be obtained. When a plurality of access networks are available in the current environment of the communication device, the number of available route candidates increases by so many number of the access networks. Therefore, even if an arbitrary place of the access or core network is congested and no QoS-assured communication is available when using a specific access network, the QoS-assured communication can be provided using another access network. In other words, the probability that a terminal user enjoys QoS assurance can be improved and also a network provider can increase its service provision throughput. Furthermore, even when a specific access network is selected and there are a plurality of core routes are available, core network resources can be efficiently allocated and a route can be selected by setting the cost value in such a way that the cost value of a route with a few available bandwidth increases and selecting a core network route.

[The Fourth Preferred Embodiment]

In the network QoS control system in the fourth preferred embodiment of the present invention, a QoS message is not independent and is included in another message, although an independent QoS message is issued in the first through third preferred embodiments as described. For example, if starting a session using a SIP server, information about the QoS request message is included in the message of SIP.

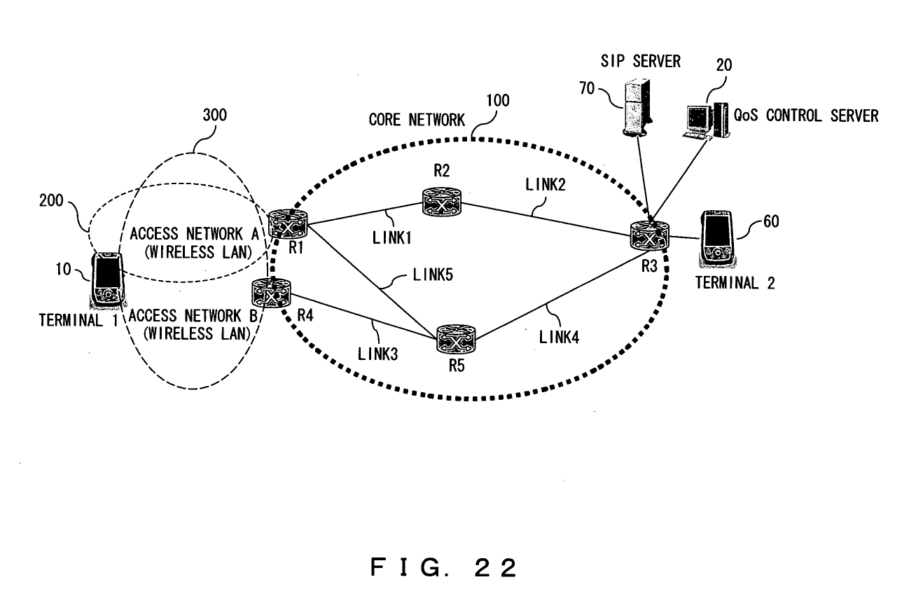

The configuration and operation of the network QoS control system in the fourth preferred embodiment of the present invention are described in detail below with reference to FIGS. 22 through 25. FIG. 22 shows the basic configuration of the network QoS control system in the fourth preferred embodiment of the present invention. In FIG. 22, it is assumed that the first terminal 10 has an IP address (10.10.0.1) in the access network A 200, and the router R1 as its gateway has an IP address (10.10. 0.253). The first terminal 10 also has an IP address (10.20.0.1) in the access network B 300, and the router R4 as its gateway has an IP address (10.20.0.253). Furthermore, the second terminal 60 has an IP address (10.30.0.1). It is also assumed that currently the links 1 through 5 have a available bandwidth of 10 Mbps in the direction of router R2→R1, a available bandwidth of 10 Mbps in the direction of R3→R2, a available bandwidth of 10 Mbps in the direction of R5→R4, a available bandwidth of 30 Mbps in the direction of R3→R5 and a available bandwidth of 20 Mbps in the direction of R5→R1, respectively. Although in the core network shown in FIG. 22, routers R1 through R5 are provided, the number of routers in an actual network configuration is not limited to this.

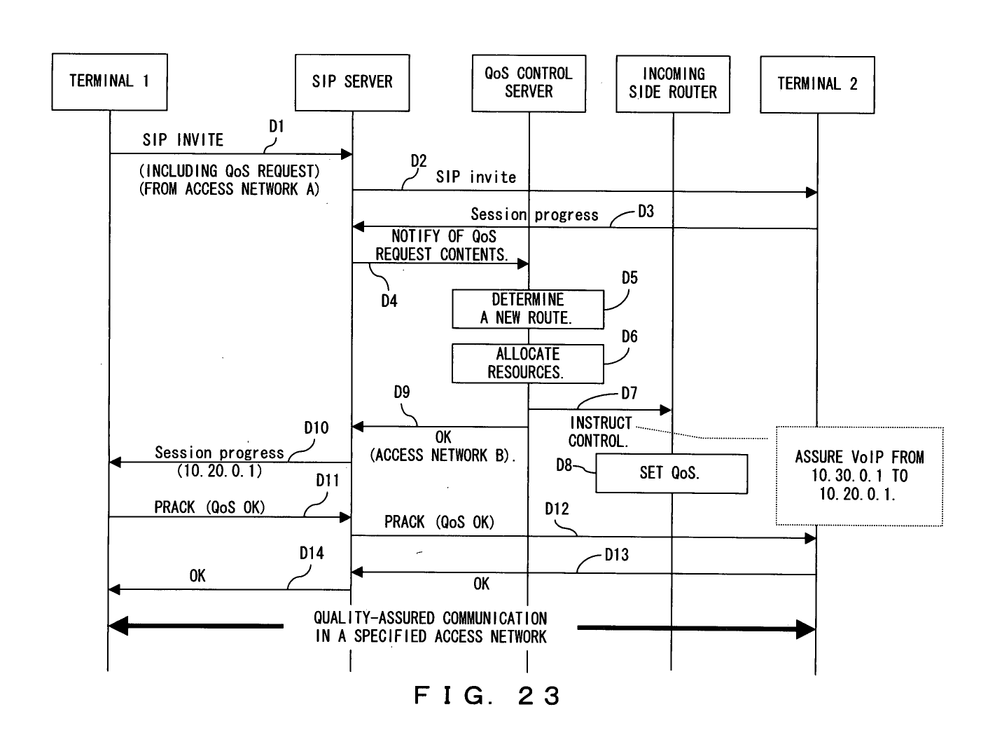

FIG. 23 is the QoS setting sequence chart in a network of the fourth preferred embodiment of the present invention shown in FIG. 22. In FIG. 23, the first terminal 10 currently issues an SIP invite message including the second terminal 60 and a QoS assure request by VoIP, which is accessible to the access networks A 200 and B 300, from the access network A toward an SIP server 70 (D1).

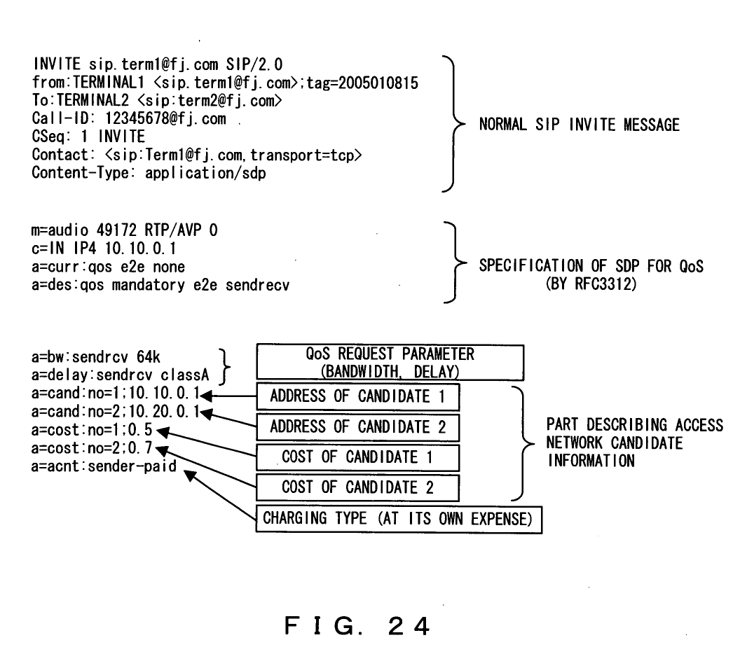

FIG. 24 shows an example of a message including QoS request contents in the SIP invite request. The SIP message is extensible, and as shown in FIG. 24, a new item can be described by an entry of “a=”. For example, it is set as follows.

a=bw:sendrcv 64k (indicating that 64K bandwidth is required in bi-directions, as a QoS request parameter)

a=delay;sendrcv classA (indicating class A delay assurance is required in bi-direction, as QoS request parameter)

a=cand:no=1;10.10.0.1 (notifying the address [10.10.0.1] of access network candidate No. 1)

a=cand:no=2;10.20.0.1 (notifying the address [10.20.0.1] of access network candidate No. 2)

a=cost:no=1;0.5 (notifying that the cost of access network candidate No. 1 is 0.5)

a=cost:no=2;0.7 (notifying that the cost of access network candidate No. 2 is 0.7)

a=acnt:sender-paid (indicating that its charge is borne by a transmitting source)

(1) A function to extract a parameter related to QoS and convey this to the QoS control server 20 when receiving an extension invite message, (2) a function to receive a response message from the QoS control server 20, receive the result of the QoS request and information to be conveyed to a terminal whose address is selected and include this information in a message to be notified to the terminal and the like are added to the SIP server 70 in the fourth preferred embodiment of the present invention.

The SIP server 70 performs a usual SIP invite message process. Furthermore, the SIP server 70 notifies the second terminal 60 of the SIP invite message (D2). The second terminal 60 reads information about the QoS request in the SIP invite message (see FIG. 24), such as, a QoS request parameter, access network candidate information (the first and second candidate addresses and the first and second candidate costs) and a charging type and knows that the first terminal 10 wants class A delay assurance in a bandwidth of 1 Mbps at its own expense. Then, the second terminal 60 confirms that this condition has no problem and returns a session progress message in response to it (D3). If the second terminal does not want QoS assurance, it can return NG.

Upon receipt of the SIP session progress message from the second terminal 60, the SIP server 70 temporarily suspends the SIP message process and notifies the QoS control server 20 of the QoS request contents (D4). As this request packet format, one that the terminal directly issues to the QoS control server as shown in each of the first through third preferred embodiments can also be used. In this case, since it is a new request, the SIP server 70 attaches a new session ID to it. Then, the QoS control server 20 receives the QoS request. Upon receipt of the message with the new session ID, the QoS control server 20 registers this message as a new session, and performs the route determination and resource allocation of the new session (D5 and D6). Then, the QoS control server 20 instructs the incoming side router R3 of VOIP data to assure the flow of the session (D7). The control instruction to the incoming side router R3 is to assure VOIP from the IP address (10.30.0.1) of the second terminal 60 to the IP address (10.20.0.1) in the access network B 300 of the first terminal 10. Upon receipt of the control instruction, the incoming side router R3 sets QoS (D8). The QoS control server 20 notifies the SIP server 70 that the QoS-assured communication via the access network B 300 is OKed (D9). The SIP server 70 notifies the IP address in the access network B 300 of the first terminal 10 of the session progress message (D10). The first terminal 10 notifies the SIP server 70 of a PRACK message (QoS OK) (D11). The SIP server 70 also notifies the second terminal 60 of the PRACK message (QoS OK) (D12). Upon receipt of this message, the second terminal 60 returns a response message of OK to the SIP server 70 (D13). Then, the SIP server 70 returns a response message of OK to the first terminal 10 (D14) Thus, the session is established, and VoIP communication is started with QoS assurance. This flow is accommodated into a path specified in the incoming side router R3, and QoS is assured.

If including an instruction on QoS control at the terminal, it can be notified by describing the following session description protocol (SDP) in the SIP message.

a=cand:no=2;10.20.0.1 (notifying a selected access network candidate and its address (10.20.0.1))

a=tos:1 (notifying that a TOS value is 1)

As described above, according to the fourth preferred embodiment, by including QoS request contents in an existing message, such as an SIP invite message, no new protocol installed in the terminal is needed or the number of messages to be exchanged between a terminal and a network can be reduced. Particularly, this preferred embodiment can be very effective when starting a session.

[The Fifth Preferred Embodiment]

In the network QoS control system of the fifth preferred embodiment of the present invention, QoS-assured resource allocation can be modified when a terminal moves by including the contents of a QoS message in a message for registering a position in a location management server when the terminal moves during communication.

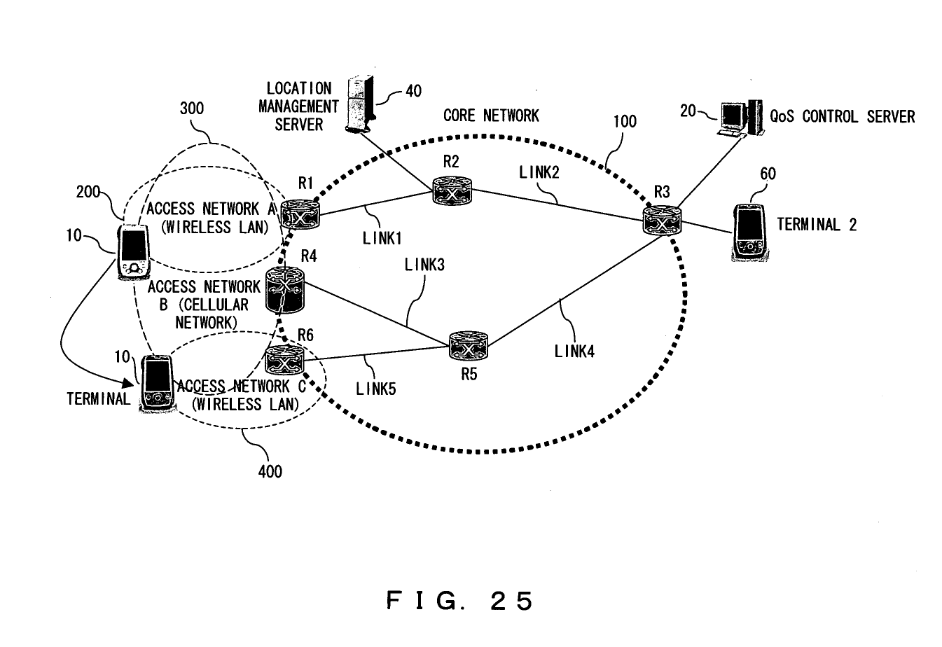

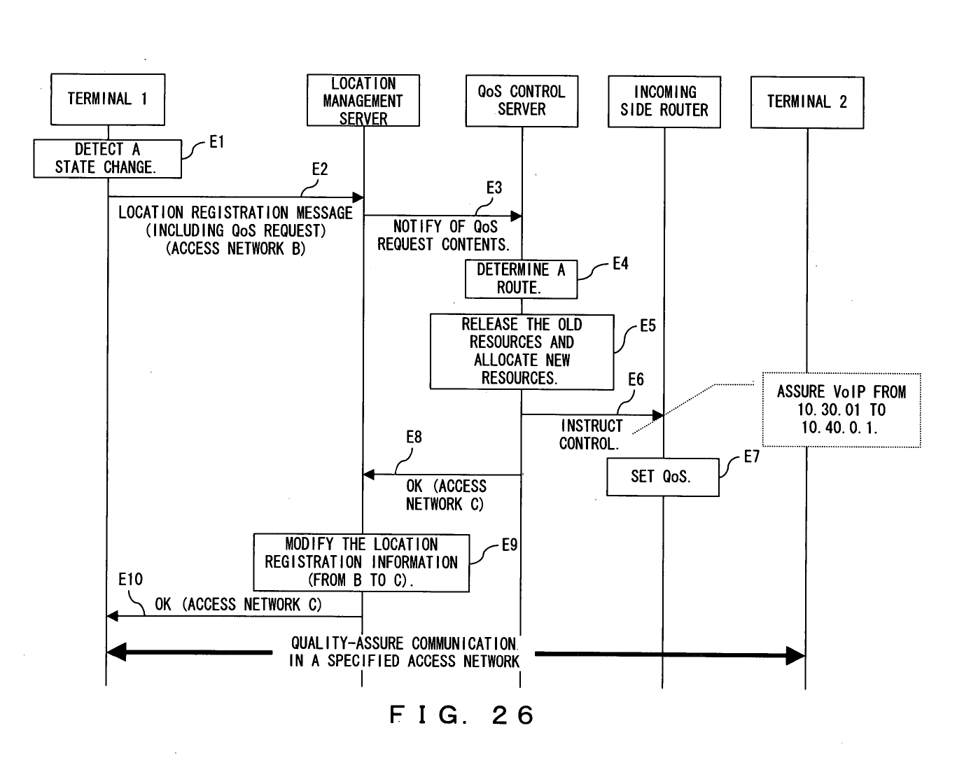

The configuration and operation of the network QoS control system in the fifth preferred embodiment of the present invention are described in detail below with reference to FIGS. 25 and 26. FIG. 25 shows the basic configuration of the network QoS control system in the fifth preferred embodiment of the present invention. In FIG. 25, it is assumed that the first terminal 10 has an IP address (10.20.0.1) in the access network B 300, and the router R4 as its gateway has an IP address (10.20. 0.253). The first terminal 10 also has an IP address (10.40.0.1) in the access network C 400, and the router R6 as its gateway has an IP address (10.40.0.253). Furthermore, the second terminal 60 has an IP address (10.30.0.1). It is also assumed that currently the links 1 through 5 have a available bandwidth of 2 Mbps in the direction of router R2→R1, a available bandwidth of 10 Mbps in the direction of R3→R2, a available bandwidth of 10 Mbps in the direction of R5→R4, a available bandwidth of 40 Mbps in the direction of R3→R5 and a available bandwidth of 10 Mbps in the direction of R5→R6, respectively. Although in the core network shown in FIG. 25, routers R1 through R6 are provided, the number of routers in an actual network configuration is not limited to this.

FIG. 26 is the QoS setting sequence chart in a network of the fifth preferred embodiment of the present invention shown in FIG. 25. In FIG. 26, the first terminal 10 is currently establishing a session with the second terminal 60 via the access network B 300. However, if the access network B 300 becomes unavailable, and the first terminal 10 moves to the access network C 400, the first terminal 10 beforehand collects a network environment accompanying the movement, information about the available access point of a wireless LAN, the base station of a cellular network, each wave intensity, delay and the like and detects the state change of an access network (E1) . Then, the first terminal 10 issues a location registration message from the access network B (cellular network) 300 to the location management server 40 (E2) . At this moment, a QoS request is included in the location registration message. Like the SIP server in the fourth preferred embodiment, (1) a function to extract a parameter related to QoS and convey this to the QoS control server 20 when receiving an extension location registration message, (2) a function to receive a response message from the QoS control server 20, receive the result of the QoS request and information to be conveyed to a terminal whose address is selected and include this information in a message to be notified to the terminal and the like are added to the location management server 40 in the fifth preferred embodiment of the present invention.

The location management server 40 extracts the QoS request contents included in the location registration message and notifies the QoS control server 20 of the QoS request contents (E3). This QoS request is the same as that issued by the terminal in the second preferred embodiment. In this case, the session before the movement assures also QoS, the request is notified with the same session ID. In this case, it can be either the terminal or location management server that generates a session ID. The QoS control server 20 reads the QoS request contents and newly determines an optimal route, according to a prescribed cost calculation expression (E4). In other words, the QoS control server 20 knows from the access network information included in this message that a new access network C 400 is available and further that the cost value of the access network B 300 increases by 0.1 due to the increase of the number of connected users, the decrease of wave intensity or the like. It is also assumed that the core resource state changes, and the available bandwidth of each of the links 3 and 4 decreases by 10 Mbps. In this situation, the respective total costs of the access networks B and C are calculated as follows, as in the first preferred embodiment.
Total cost via access network C=0.4 + 1/10+ 1/40=0.525
Total cost via access network B=0.8 + 1/10+ 1/40=0.925

Therefore, it is determined that the access network C 400 is better, and the route via the access network C 400 is adopted. The calculation result of the calculation happens to be the same as that calculated by expressions 8 and 9.

Then, the QoS control server 20 releases the old resources, and newly allocates the resources (ES) . In other words, the QoS control server 20 allocates a bandwidth. Specifically, the QoS control server 20 updates the available bandwidth information of links constituting the determined route and releases the resources on the route before the modification by further updating the available bandwidth information. Then, the QoS control server 20 issues a control instruction to the incoming side router R3 and sets session assurance in a new location (E6). The control instruction to the incoming side router R3 is to assure VoIP from the IP address (10.30.0.1) of the second terminal 60 to the IP address (10.40.0.1) in the access C 400 of the first terminal 10. The incoming side router R3 sets QoS according to this instruction (E7) . The QoS control server 20 notifies the location management server 40 that QoS assurance via the access network C 400 is OKed (E8). Upon receipt of this notice, the location management server 40 modifies the location registration information of the terminal from the access network B to C (E9). Then, the location management server 40 notifies the first terminal 10 that QoS communication can be assured via the access network C 400, in response to the location registration message (E10). Thus, the terminal conducts QoS-assured communication using the access network C.

As described above; according to the fifth preferred embodiment, including QoS request contents in an existing message, that is, location registration message, there is no need to install a new protocol in a terminal, and the number of messages to be exchanged between the terminal and a network can be reduced. Particularly, in the fifth preferred embodiment, this method can be very effective when a terminal moves.

[The Sixth Preferred Embodiment]

In the network QoS control system in each of the first through fifth preferred embodiments, the control server shown in FIG. 7 is used as a server for controlling QoS and also QoS control is performed on a condition that a QoS request packet contains information about the state of an access network. In this case, QoS cannot be realized without including information about the state of an access network. Therefore, in order to realize QoS without including information about the state of an access network, the network QoS control system in the sixth preferred embodiment of the present invention is configured so that a QoS control server can make an inquiry about the information about an access network state for a dedicated server for collectively managing information about an access network state.

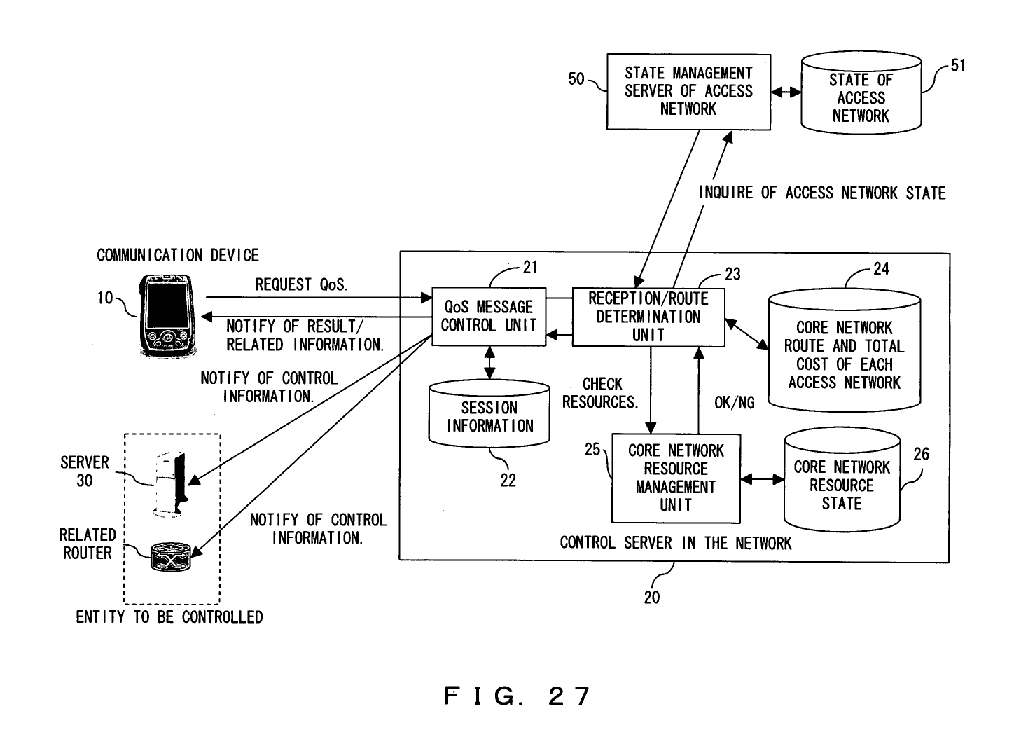

FIG. 27 shows the basic configuration of the network QoS control system in the sixth preferred embodiment of the present invention. The configuration of the QoS control server 20 in a network, shown in FIG. 27 is basically that of the QoS control server in the first preferred embodiment shown in FIG. 7. However, this configuration of the QoS control server 20 differs from that shown in FIG. 7 in that in FIG. 27 a reception/route determination unit 23 makes an inquiry about information the access network state for a state management server 50 which collectively manages the access network state as a dedicated server. The state management server 50 obtains information about the access network state by referring to information stored in a data storage unit 51 for managing the state of an access network and replies the obtained information about the access network state to the reception/route determination unit 23. As a result, the reception/route determination unit 23 of the QoS control server 20 calculates a total cost, using the information about the access network state replied from the state management server 50, as described above, and performs optimal route determination and resource allocation, based on the total cost.

As described above, according to the sixth preferred embodiment, even when a QoS request message does not contain information about an access network state, QoS control can be performed using access network state information collected by a dedicated server in a network. Thus, a user can be released from the troublesome of including information about an access network in a request message and transmitting the information from a terminal. Since a dedicated server collectively manages information, such as the number of connected users, a available bandwidth and the like of an access network, the terminal can ask for the provision of a QoS-assured service regardless of the state of the access network.

[The Seventh Preferred Embodiment]

In the network QoS control system of each of the first through sixth preferred embodiments, although the QoS control server has to do with how to obtain information about the state of an access network, it does not has to do with how to apply a measured rate to quality-assured communication. The network QoS control system in the seventh preferred embodiment proposes the specific measure about how to apply a measured rate to quality-assured communication service which is expected to expand in the future. In the network Qos control system of this preferred embodiment, which bears service charge, that is, a measured rate is applied to, an originating user or a terminating user, by negotiations before setting QoS when a quality-assured communication service is desired, is determined and then QoS is set. Specifically, whether to receive a quality-assured communication service on the relevant charging condition is determined by negotiations with a partner communication device by notifying the partner communication device of information about the charging condition before staring quality-assured communication using setting information about the charging condition contained in the QoS request contents of a QoS request message and obtaining whether to agree on the charging condition from the party communication device in response to the notice.

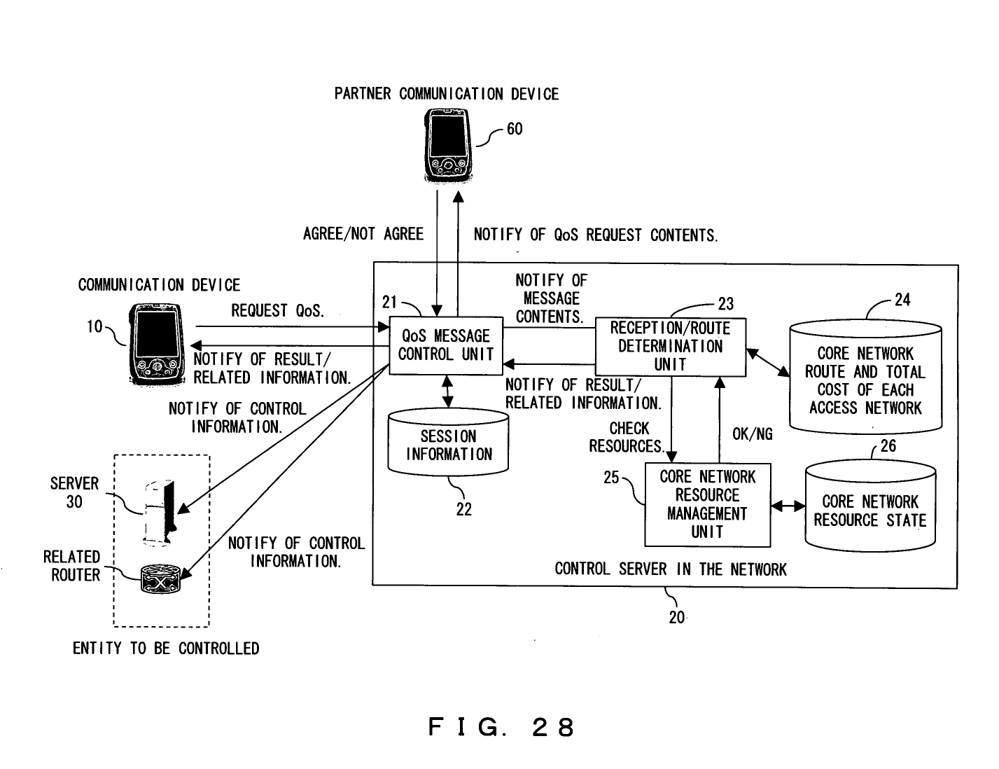

FIG. 28 shows the basic configuration of the network QoS control system in the seventh preferred embodiment of the present invention. The configuration of the QoS control server in the seventh preferred embodiment shown in FIG. 28 is basically the same as that of the QoS control server in the first preferred embodiment shown in FIG. 7 or in the sixth preferred embodiment shown in FIG. 27. However, this QoS control server differs from that shown in FIG. 7 or 27 in that the Qos control server for controlling the QoS of a network notifies a partner communication device of QoS request contents including a charging condition before starting quality-assured communication and obtaining whether to agree on the charging condition from the party communication device in response to the notice. Specifically, as shown in FIG. 28, the QoS message control unit 21 of the QoS control server 20 receives a QoS request message containing a charging condition from the first terminal 10 (see FIG. 5 and the like for the request message). When confirming that a charging condition are described in the QoS request message, the QoS message control unit 21 notifies the second terminal 60, being its communication partner, of QoS request contents including setting information about the charging condition. Then, the second terminal 60 reads the QoS request contents including the setting information and returns whether to agree on the charging conditions as a response packet.

The charging conditions included in the QoS request contents are as follows.
(a) The partner communication device bears the cost of a QoS-assured service.
(b) Each party bears a half of the cost of a QoS-assured service.
(c) A communication request source bears the cost of a QoS-assured service.

A partner communication device is notified of QoS request contents including charging conditions in two pieces of timing; before and after performing route determination and resource allocation.

If the second terminal 60, being the communication partner, does not agree on quality-assured communication with a notified charging condition when it is notified before performing route determination and resource allocation, the reception/route determination unit 23 of the QoS control server 20 can be prevented from performing useless route control and resource allocation.

If it is notified after performing route determination and resource allocation, there is no need to notify the second terminal 60, being the communication partner, of failing to establish quality-assured communication and to cancel it, thereby releasing the second terminal 60, being the communication partner, from troublesomeness.

As described above, according to the seventh preferred embodiment, when charging a quality-assured communication service, which is expected to expand in the future, at a measured rate, which bears its cost, an originating or terminating party can be freely determined by negotiations before QoS setting, and the quality-assured communication service can be realized by mutual consent.

As described above, according to the present invention, if a user has a plurality of communication access means, the user can determine which of the communication access means to use taking the entire network into consideration when conducting quality-assured communication. Therefore, resources can be efficiently allocated, and a lot of users can enjoy a QoS service. Furthermore, with the help of a mobile communication device, a user that wants quality-assured communication can dynamically select an optimal route taking into consideration information, such as the current state of core and access networks, communication contents, the intention of the communication partner and the like. Furthermore, since a communication quality-assured service can be provided with the selection or negotiation on a charging method, a communication service can be provided with good communication quality assurance such that the conventional best-effort type communication cannot obtain.

What is claimed is:

1. A network QoS control system, comprising:
a user terminal having a plurality of communication interfaces; and
a network QoS control device for dynamically determining a QoS-assured route at end-to-end, based on a QoS request from the user terminal, taking the plurality of interfaces into consideration.

2. A network QoS control system in a packet network for providing a QoS-assured service, comprising:
a user terminal accessible to a plurality of access network; and
a QoS control server for receiving a QoS request from the user terminal and processing the request,
the QoS control server comprises
a QoS message control unit for dynamically receiving a QoS request including all available access network information and processing a message generated using the received QoS request as a trigger;
a resource management unit for managing resources of a core network for assuring QoS; and
a route determination unit capable of checking resources used in the case of each available access network, based on request contents of the QoS request by the resource management unit, selecting an optimal access network and an optimal core network route, using the request contents received by the QoS message control unit and a result of the resource check by the resource management unit and determining a route.

3. A network QoS control system, comprising:
a user mobile terminal having a plurality of communication interfaces; and
a network QoS control device for dynamically determining a QoS-assured route at end-to-end, based on a QoS request from the user terminal taking the plurality of interfaces into considering, and allocating resources.

4. A network QoS control system in a packet network for providing a QoS-assured service and a mobile communication service, comprising:
a user terminal accessible to a plurality of access networks; and
a QoS control server for receiving a QoS request from the user terminal and processing the request,
the QoS control server comprises;
a QoS message control unit for dynamically receiving a QoS request including all available access network information and processing a message generated using the received QoS request as a trigger;
a resource management unit for managing the state in use and available bandwidth of a core network for assuring QoS; and
a route determination unit capable of checking resources used in the case of each available access network, based on request contents of the QoS request by the resource management unit, selecting an optimal access network and an optimal core network route, using the request contents received by the QoS message control unit and a result of the resource check by the resource management unit and determining a route.

5. The network QoS control system according to claim 2, wherein
said route determining unit selects a core network route using one of all the available access networks as a candidate and selecting an optimal core network route from the candidates according to the available bandwidth of a link constituting the core network route and an optimal access network from the all the available access network.

6. The network QoS control system according to claim 2, wherein
when the QoS request includes the information indicating the state of each access network, said route determining unit for determining which access network should be used, using information indicating a state of each access network and determining an optimal route in combination with a available bandwidth of a core network.

7. The network QoS control system according to claim 6, wherein
the information indicating the state of an access network includes a delay value, wave intensity, an available bandwidth and the number of connected users.

8. The network QoS control system according to claim 2, wherein
when receiving the QoS request, said route determination unit obtains information indicating the state of each access network from a server for collecting and managing the state of each access network provided for a packet network and determining an optimal route.

9. The network QoS control system according to claim 2, wherein
said QoS message control means comprises:
a unit for notifying a partner terminal of the request contents on a charging condition,
said unit reflects a response from the partner terminal in QoS setting.

10. The network QoS control system in a packet network comprising an Ipv4 or Ipv6 network as an access network and a dual network in which Ipv4/Ipv6 conversion is available as a core network, according to claim 2, wherein
a QoS request is issued to the QoS control server, using either of the access networks, and
said QoS control server calculates a total cost, based on respective resource states of the core and access networks and determines a route whose cost is a minimum as an optimal route.

11. The network QoS control system according to claim 2, wherein
when the QoS request does not include information about an access network state, QoS control is performed by obtaining the information about an access network state from a server for collectively collecting and managing the state of an access network.

12. A network QoS control method for dynamically receiving a QoS request including all available access network information, determining a network route and an access network which meet the QoS request and assuring QoS at end-to-end.

13. The network QoS control method according to claim 12, wherein
when an access network to be used by a user terminal is modified during communication, a new QoS request including information about an access network state of a movement destination is dynamically received from the existing access network, a network route and an access network which meet the QoS request is newly determined and QoS is assured at end-to-end.

14. The network QoS control method according to claim 12, wherein
a QoS request is included in an existing message and the QoS request is processed in the course of a process of the existing message.

15. The network QoS control method according to claim 14, wherein
the existing message is an SIP invite message.

16. The network QoS control method according to claim 13, wherein
a QoS request is included in a location registration modifying message accompanying a movement during communication and the QoS request is processed in the course of a process of the location registration modification.
